(19) United States
(12) Patent Application Publication
(10) Pub. No.: US 2022/0089278 A1
(43) Pub. Date: Mar. 24, 2022

(54) BLADE AND ROTOR OF ROTOR CRAFT, AND ROTOR CRAFT

(71) Applicant: Beijing Airlango Technology Co., LTD., Beijing (CN)

(72) Inventors: Dongyue ZHOU, Beijing (CN); Aolin GAO, Beijing (CN); Peng LU, Beijing (CN); Cong MA, Beijing (CN); Hesen TANG, Beijing (CN); Jinlai LIU, Beijing (CN); Zhenkai LI, Beijing (CN); Hengsheng SUN, Beijing (CN); Bo YAN, Beijing (CN); Xinhong JIANG, Beijing (CN)

(21) Appl. No.: 17/541,728

(22) Filed: Dec. 3, 2021

Related U.S. Application Data
(63) Continuation of application No. PCT/CN2020/091310, filed on May 20, 2020.

(30) Foreign Application Priority Data
Dec. 6, 2019 (CN) 201911245181.3
Dec. 6, 2019 (CN) 201922193914.5

(51) Int. Cl. B64C 27/46; B64C 27/467; B64C 27/473; B64C 27/32

(52) U.S. Cl. CPC B64C 27/463; B64C 27/32; B64C 27/473; B64C 27/467

(57) ABSTRACT

The present disclosure relates to a blade and a rotor of a rotor craft, and a rotor craft. The blade includes a blade root, a blade tip, and an upper aerofoil and a lower aerofoil disposed vertically opposite to each other. One sides of the upper aerofoil and the lower aerofoil are connected to form a front edge, and other sides of the upper aerofoil and the lower aerofoil are connected to form a tail edge. The upper aerofoil is defined by an upper aerofoil characteristic line formed by (kx, ky, kz) defined by a plurality of coordinate pairs. The lower aerofoil is defined by a lower aerofoil characteristic line formed by (kx, ky, kz) defined by a plurality of coordinate pairs.

### CROSS REFERENCE TO RELEVANT APPLICATIONS

The present application claims the priority of the Chinese patent application filed on Dec. 6, 2019 before the Chinese Patent Office with the application number of 201922193914.5 and the title of “BLADE AND ROTOR OF ROTOR CRAFT, AND ROTOR CRAFT”, and the Chinese patent application filed on Dec. 6, 2019 before the Chinese Patent Office with the application number of 201911245181.3 and the title of “ROTOR OF ROTATING CRAFT, AND ROTOR CRAFT” which are incorporated herein in its entirety by reference.

### TECHNICAL FIELD

The present disclosure relates to the technical field of aircrafts, and specifically, to a blade and a rotor of a rotor craft, and a rotor craft.

### BACKGROUND

A rotor is an important part of a rotor craft, and is configured to convert the power of an output shaft of a motor or an engine to thrust or lift, so as to realize take-off and landing, hovering, traveling, or tilting of the rotor craft. A blade of a rotor in the related art has a low motor efficiency under limitation of a profile and a structure, failing to satisfy required thrust during operation. In addition, generally, the rotor of the rotor craft generates relatively large noise. When the rotor craft is used for logistics in densely populated regions, noise generated by the rotor greatly disturbs the daily life of residents, affecting user experience.

### SUMMARY

The present disclosure provides a blade of a rotor craft. The blade includes a blade root, a blade tip, and an upper aerofoil and a lower aerofoil disposed vertically opposite to each other. One sides of the upper aerofoil and the lower aerofoil are connected to form a front edge, and other sides of the upper aerofoil and the lower aerofoil are connected to form a tail edge. The upper aerofoil is defined by an upper aerofoil characteristic line formed by (kx, ky, kz) defined by a plurality of coordinate pairs (x, y, z). The lower aerofoil is defined by a lower aerofoil characteristic line formed by (kx, ky, kz) defined by a plurality of coordinate pairs (x, y, z). The upper aerofoil characteristic line and the lower aerofoil characteristic line are defined according to following tables:

| Upper aerofoil characteristic line e | | | Upper aerofoil characteristic line g | | | Upper aerofoil characteristic line i | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.77610 | 2.91754 | 157.55200 | −10.15950 | 1.89922 | 196.94000 | −10.23250 | 1.52494 |
| 113.58400 | −11.46230 | 3.10200 | 157.55200 | −9.91255 | 2.06417 | 196.94000 | −10.02740 | 1.66809 |
| 113.58400 | −10.98050 | 3.25954 | 157.55200 | −9.52751 | 2.21508 | 196.94000 | −9.70404 | 1.80392 |
| 113.58400 | −10.33370 | 3.37583 | 157.55200 | −9.00615 | 2.34012 | 196.94000 | −9.26354 | 1.92207 |
| 113.58400 | −9.52457 | 3.45183 | 157.55200 | −8.35072 | 2.43996 | 196.94000 | −8.70785 | 2.02317 |
| 113.58400 | −8.55966 | 3.47650 | 157.55200 | −7.56599 | 2.50530 | 196.94000 | −8.04075 | 2.09930 |
| 113.58400 | −7.44593 | 3.44784 | 157.55200 | −6.65755 | 2.53419 | 196.94000 | −7.26694 | 2.14861 |
| 113.58400 | −6.19462 | 3.36224 | 157.55200 | −5.63438 | 2.52314 | 196.94000 | −6.39400 | 2.16788 |
| 113.58400 | −4.81762 | 3.21894 | 157.55200 | −4.50614 | 2.47100 | 196.94000 | −5.43013 | 2.15579 |
| 113.58400 | −3.33128 | 3.01760 | 157.55200 | −3.28611 | 2.37672 | 196.94000 | −4.38664 | 2.11101 |
| 113.58400 | −1.75295 | 2.75910 | 157.55200 | −1.98849 | 2.24019 | 196.94000 | −3.27562 | 2.03301 |
| 113.58400 | −0.10233 | 2.44542 | 157.55200 | −0.62940 | 2.06210 | 196.94000 | −2.11088 | 1.92186 |
| 113.58400 | 1.60038 | 2.07915 | 157.55200 | 0.77458 | 1.84363 | 196.94000 | −0.90659 | 1.77801 |
| 113.58400 | 3.33284 | 1.66357 | 157.55200 | 2.20510 | 1.58640 | 196.94000 | 0.32155 | 1.60228 |
| 113.58400 | 5.07381 | 1.20659 | 157.55200 | 3.64465 | 1.29665 | 196.94000 | 1.55849 | 1.40008 |
| 113.58400 | 6.79966 | 0.71417 | 157.55200 | 5.07381 | 0.97894 | 196.94000 | 2.78763 | 1.17540 |
| 113.58400 | 8.48807 | 0.19246 | 157.55200 | 6.47412 | 0.63715 | 196.94000 | 3.99309 | 0.93087 |
| 113.58400 | 10.11600 | −0.34878 | 157.55200 | 7.82630 | 0.27797 | 196.94000 | 5.15819 | 0.67142 |
| 113.58400 | 11.66310 | −0.89760 | 157.55200 | 9.11321 | −0.09004 | 196.94000 | 6.26801 | 0.40352 |
| 113.58400 | 13.10850 | −1.44033 | 157.55200 | 10.31720 | −0.45705 | 196.94000 | 7.30713 | 0.13467 |
| 113.58400 | 14.43440 | −1.96134 | 157.55200 | 11.42290 | −0.81150 | 196.94000 | 8.26209 | −0.12618 |
| 113.58400 | 15.62290 | −2.44856 | 157.55200 | 12.41510 | −1.14480 | 196.94000 | 9.11955 | −0.37258 |
| 113.58400 | 16.65660 | −2.89249 | 157.55200 | 13.27910 | −1.45043 | 196.94000 | 9.86679 | −0.59975 |
| 113.58400 | 17.51940 | −3.28980 | 157.55200 | 14.00170 | −1.72682 | 196.94000 | 10.49230 | −0.80704 |
| 113.58400 | 18.19240 | −3.62849 | 157.55200 | 14.56660 | −1.96550 | 196.94000 | 10.98220 | −0.98811 |
| 113.58400 | 18.66530 | −3.87812 | 157.55200 | 14.96430 | −2.14251 | 196.94000 | 11.32720 | −1.12323 |
| 113.58400 | 18.94280 | −4.02223 | 157.55200 | 15.19750 | −2.24439 | 196.94000 | 11.52950 | −1.20092 |
| 113.58400 | 19.03400 | −4.06770 | 157.55200 | 15.27400 | −2.27632 | 196.94000 | 11.59580 | −1.22517 |

| Lower aerofoil characteristic line e | | | Lower aerofoil characteristic line g | | | Lower aerofoil characteristic line i | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.83620 | 2.66095 | 157.55200 | −10.19640 | 1.68741 | 196.94000 | −10.25670 | 1.35074 |
| 113.58400 | −11.59980 | 2.51515 | 157.55200 | −9.99698 | 1.57975 | 196.94000 | −10.08270 | 1.26967 |
| 113.58400 | −11.18610 | 2.38183 | 157.55200 | −9.65378 | 1.49057 | 196.94000 | −9.78671 | 1.20803 |
| 113.58400 | −10.60200 | 2.23039 | 157.55200 | −9.17094 | 1.39461 | 196.94000 | −9.37143 | 1.14442 |
| 113.58400 | −9.84782 | 2.07165 | 157.55200 | −8.54928 | 1.30069 | 196.94000 | −8.83785 | 1.08615 |
| 113.58400 | −8.92789 | 1.90433 | 157.55200 | −7.79218 | 1.20755 | 196.94000 | −8.18883 | 1.03194 |
| 113.58400 | −7.84931 | 1.72554 | 157.55200 | −6.90533 | 1.11251 | 196.94000 | −7.42917 | 0.97933 |
| 113.58400 | −6.62327 | 1.53206 | 157.55200 | −5.89768 | 1.01241 | 196.94000 | −6.56639 | 0.92535 |
| 113.58400 | −5.26231 | 1.32031 | 157.55200 | −4.77928 | 0.90377 | 196.94000 | −5.60897 | 0.86679 |
| 113.58400 | −3.78320 | 1.08804 | 157.55200 | −3.56371 | 0.78396 | 196.94000 | −4.56839 | 0.80101 |
| 113.58400 | −2.20399 | 0.83331 | 157.55200 | −2.26554 | 0.65054 | 196.94000 | −3.45702 | 0.72557 |
| 113.58400 | −0.54493 | 0.55564 | 157.55200 | −0.90127 | 0.50219 | 196.94000 | −2.28888 | 0.63887 |
| 113.58400 | 1.17301 | 0.25443 | 157.55200 | 0.51207 | 0.33742 | 196.94000 | −1.07846 | 0.53919 |
| 113.58400 | 2.92693 | −0.06952 | 157.55200 | 1.95577 | 0.15582 | 196.94000 | 0.15831 | 0.42566 |
| 113.58400 | 4.69407 | −0.41478 | 157.55200 | 3.41125 | −0.04252 | 196.94000 | 1.40556 | 0.29785 |
| 113.58400 | 6.45011 | −0.77825 | 157.55200 | 4.85854 | −0.25622 | 196.94000 | 2.64624 | 0.15631 |
| 113.58400 | 8.17205 | −1.15683 | 157.55200 | 6.27875 | −0.48381 | 196.94000 | 3.86419 | 0.00178 |
| 113.58400 | 9.83561 | −1.54581 | 157.55200 | 7.65191 | −0.72261 | 196.94000 | 5.04229 | −0.16394 |
| 113.58400 | 11.41880 | −1.94067 | 157.55200 | 8.95985 | −0.96997 | 196.94000 | 6.16499 | −0.33900 |
| 113.58400 | 12.89910 | −2.33422 | 157.55200 | 10.18400 | −1.22109 | 196.94000 | 7.21634 | −0.51974 |
| 113.58400 | 14.25660 | −2.72046 | 157.55200 | 11.30780 | −1.47201 | 196.94000 | 8.18205 | −0.70312 |
| 113.58400 | 15.47220 | −3.09200 | 157.55200 | 12.31520 | −1.71762 | 196.94000 | 9.04844 | −0.88512 |
| 113.58400 | 16.52810 | −3.44111 | 157.55200 | 13.19160 | −1.95244 | 196.94000 | 9.80273 | −1.06147 |
| 113.58400 | 17.40920 | −3.76033 | 157.55200 | 13.92420 | −2.17112 | 196.94000 | 10.43390 | −1.22801 |
| 113.58400 | 18.09600 | −4.03990 | 157.55200 | 14.49670 | −2.36662 | 196.94000 | 10.92790 | −1.37913 |
| 113.58400 | 18.57650 | −4.25748 | 157.55200 | 14.89820 | −2.52130 | 196.94000 | 11.27490 | −1.49999 |
| 113.58400 | 18.85600 | −4.39288 | 157.55200 | 15.13230 | −2.61847 | 196.94000 | 11.47740 | −1.57628 |
| 113.58400 | 18.94730 | −4.43768 | 157.55200 | 15.20870 | −2.65068 | 196.94000 | 11.54360 | −1.60156 |

A direction x is a spanwise direction of a rotor, a direction y is a chord length direction of the rotor, a direction z is a thickness direction of the rotor, and k=a/229, where a is a radius value of the rotor, and a maximum error of each of the upper aerofoil characteristic line and the lower aerofoil characteristic line equals to ±3%.

According to the above technical solutions, in the present disclosure, the upper aerofoil characteristic line and the lower aerofoil characteristic line in a main pulling force generation region of the blade are optimized, so that the rotor has optimal operating sections in a spanwise direction, thereby reducing air resistance, and enhancing a pulling force and efficiency. In this way, the time of endurance of the rotor craft can be prolonged. In addition, noise generated during flight of the rotor craft can be reduced, thereby improving user experience.

Other features and advantages of the present disclosure are described in detail in the detailed description of the embodiments below.

### BRIEF DESCRIPTION OF THE DRAWINGS

The accompanying drawings are intended to provide further understanding of the present disclosure and constitute a part of this specification. The accompanying drawings and the specific implementations below are used together for explaining the present disclosure rather than constituting a limitation to the present disclosure. In the accompany drawings:

FIG. 1 is a three-dimensional schematic structural diagram of a blade of a rotor according to an exemplary embodiment.

FIG. 2 is a planar view of a blade of a rotor according to an exemplary embodiment.

FIG. 3 is a comparison diagram of a motor efficiency of a blade according to the present disclosure versus a T-motor pure carbon blade.

### DETAILED DESCRIPTION OF THE EMBODIMENTS

Specific implementations of the present disclosure are described in detail below with reference to the accompanying drawings. It should be understood that the specific implementations described herein are merely used to describe and explain the present disclosure, but are not intended to limit the present disclosure.

The orientation terms such as up and down in the embodiments are based on normal operating attitudes of a rotor and a rotor craft after the rotor is mounted to the craft, which are not to be construed as a limitation.

A rotor of a rotor craft and the rotor craft of the present disclosure are described in detail below with reference to the drawings. In the case of no conflict, features in the following embodiments and implementations may be combined with each other.

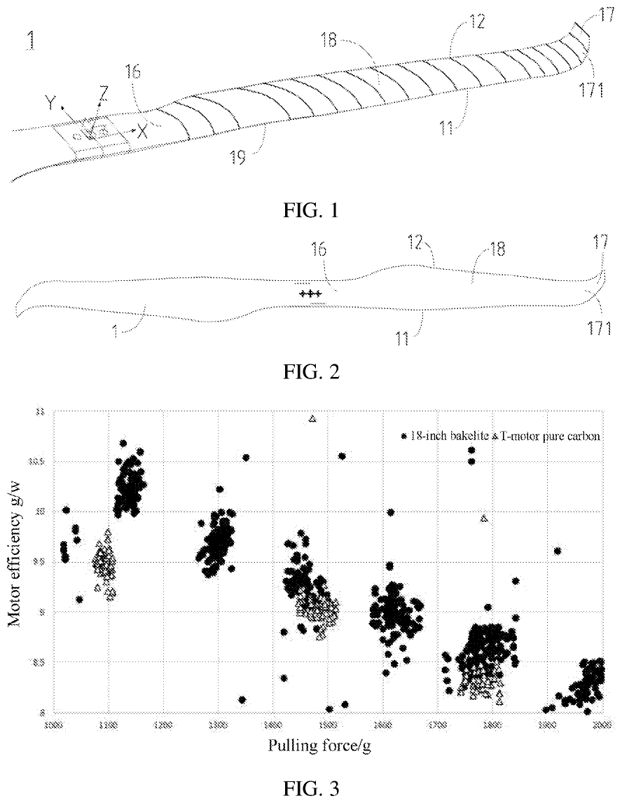

As shown in FIG. 1 and FIG. 2, the present disclosure provides a rotor of a rotor craft. The rotor includes a blade 1 and a hub. The blade 1 is mounted to a driving assembly of the rotor craft by using the hub. For example, the driving assembly may be a rotary motor mounted to a fuselage of the rotor craft. An output shaft of the rotary motor is connected to the hub, to drive the blade 1 to rotate. A plurality of rotors may be disposed on the fuselage of the rotor craft. A flying attitude of the rotor craft may be adjusted by adjusting rotation speeds and attitudes of the rotors, so as to switch among hovering, traveling, and tilting.

The blade 1 of the present disclosure may be made of any material in the related art, including but not limited to a metal material, plastic, carbon fiber, and the like. In addition, processing means in the related art such as molding, stamping, or forging may be used for manufacturing.

As shown in FIG. 1, the blade 1 includes a blade root 16, a blade tip 17, and an upper aerofoil 18 and a lower aerofoil 19 disposed vertically opposite to each other. One sides of the upper aerofoil 18 and the lower aerofoil 19 are connected to form a front edge 11, and other sides of the upper aerofoil and the lower aerofoil are connected to form a tail edge 12. The upper aerofoil 18 is defined by an upper aerofoil characteristic line formed by (kx, ky, kz) defined by a plurality of coordinate pairs (x, y, z). The lower aerofoil 19 is defined by a lower aerofoil characteristic line formed by (kx, ky, kz) defined by a plurality of coordinate pairs (x, y, z). The upper aerofoil characteristic line and the lower aerofoil characteristic line are defined according to following tables:

TABLE 1a
Characteristic point coordinates of upper aerofoil characteristic lines

| Upper aerofoil characteristic line e | | | Upper aerofoil characteristic line g | | | Upper aerofoil characteristic line i | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.77610 | 2.91754 | 157.55200 | −10.15950 | 1.89922 | 196.94000 | −10.23250 | 1.52494 |
| 113.58400 | −11.46230 | 3.10200 | 157.55200 | −9.91255 | 2.06417 | 196.94000 | −10.02740 | 1.66809 |
| 113.58400 | −10.98050 | 3.25954 | 157.55200 | −9.52751 | 2.21508 | 196.94000 | −9.70404 | 1.80392 |
| 113.58400 | −10.33370 | 3.37583 | 157.55200 | −9.00615 | 2.34012 | 196.94000 | −9.26354 | 1.92207 |
| 113.58400 | −9.52457 | 3.45183 | 157.55200 | −8.35072 | 2.43996 | 196.94000 | −8.70785 | 2.02317 |
| 113.58400 | −8.55966 | 3.47650 | 157.55200 | −7.56599 | 2.50530 | 196.94000 | −8.04075 | 2.09930 |
| 113.58400 | −7.44593 | 3.44784 | 157.55200 | −6.65755 | 2.53419 | 196.94000 | −7.26694 | 2.14861 |
| 113.58400 | −6.19462 | 3.36224 | 157.55200 | −5.63438 | 2.52314 | 196.94000 | −6.39400 | 2.16788 |
| 113.58400 | −4.81762 | 3.21894 | 157.55200 | −4.50614 | 2.47100 | 196.94000 | −5.43013 | 2.15579 |
| 113.58400 | −3.33128 | 3.01760 | 157.55200 | −3.28611 | 2.37672 | 196.94000 | −4.38664 | 2.11101 |
| 113.58400 | −1.75295 | 2.75910 | 157.55200 | −1.98849 | 2.24019 | 196.94000 | −3.27562 | 2.03301 |
| 113.58400 | −0.10233 | 2.44542 | 157.55200 | −0.62940 | 2.06210 | 196.94000 | −2.11088 | 1.92186 |
| 113.58400 | 1.60038 | 2.07915 | 157.55200 | 0.77458 | 1.84363 | 196.94000 | −0.90659 | 1.77801 |
| 113.58400 | 3.33284 | 1.66357 | 157.55200 | 2.20510 | 1.58640 | 196.94000 | 0.32155 | 1.60228 |
| 113.58400 | 5.07381 | 1.20659 | 157.55200 | 3.64465 | 1.29665 | 196.94000 | 1.55849 | 1.40008 |
| 113.58400 | 6.79966 | 0.71417 | 157.55200 | 5.07381 | 0.97894 | 196.94000 | 2.78763 | 1.17540 |
| 113.58400 | 8.48807 | 0.19246 | 157.55200 | 6.47412 | 0.63715 | 196.94000 | 3.99309 | 0.93087 |
| 113.58400 | 10.11600 | −0.34878 | 157.55200 | 7.82630 | 0.27797 | 196.94000 | 5.15819 | 0.67142 |
| 113.58400 | 11.66310 | −0.89760 | 157.55200 | 9.11321 | −0.09004 | 196.94000 | 6.26801 | 0.40352 |
| 113.58400 | 13.10850 | −1.44033 | 157.55200 | 10.31720 | −0.45705 | 196.94000 | 7.30713 | 0.13467 |
| 113.58400 | 14.43440 | −1.96134 | 157.55200 | 11.42290 | −0.81150 | 196.94000 | 8.26209 | −0.12618 |
| 113.58400 | 15.62290 | −2.44856 | 157.55200 | 12.41510 | −1.14480 | 196.94000 | 9.11955 | −0.37258 |
| 113.58400 | 16.65660 | −2.89249 | 157.55200 | 13.27910 | −1.45043 | 196.94000 | 9.86679 | −0.59975 |
| 113.58400 | 17.51940 | −3.28980 | 157.55200 | 14.00170 | −1.72682 | 196.94000 | 10.49230 | −0.80704 |
| 113.58400 | 18.19240 | −3.62849 | 157.55200 | 14.56660 | −1.96550 | 196.94000 | 10.98220 | −0.98811 |
| 113.58400 | 18.66530 | −3.87812 | 157.55200 | 14.96430 | −2.14251 | 196.94000 | 11.32720 | −1.12323 |
| 113.58400 | 18.94280 | −4.02223 | 157.55200 | 15.19750 | −2.24439 | 196.94000 | 11.52950 | −1.20092 |
| 113.58400 | 19.03400 | −4.06770 | 157.55200 | 15.27400 | −2.27632 | 196.94000 | 11.59580 | −1.22517 |

TABLE 1b
Characteristic point coordinates of lower aerofoil characteristic lines

| Lower aerofoil characteristic line e | | | Lower aerofoil characteristic line g | | | Lower aerofoil characteristic line i | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.83620 | 2.66095 | 157.55200 | −10.19640 | 1.68741 | 196.94000 | −10.25670 | 1.35074 |
| 113.58400 | −11.59980 | 2.51515 | 157.55200 | −9.99698 | 1.57975 | 196.94000 | −10.08270 | 1.26967 |
| 113.58400 | −11.18610 | 2.38183 | 157.55200 | −9.65378 | 1.49057 | 196.94000 | −9.78671 | 1.20803 |
| 113.58400 | −10.60200 | 2.23039 | 157.55200 | −9.17094 | 1.39461 | 196.94000 | −9.37143 | 1.14442 |
| 113.58400 | −9.84782 | 2.07165 | 157.55200 | −8.54928 | 1.30069 | 196.94000 | −8.83785 | 1.08615 |
| 113.58400 | −8.92789 | 1.90433 | 157.55200 | −7.79218 | 1.20755 | 196.94000 | −8.18883 | 1.03194 |
| 113.58400 | −7.84931 | 1.72554 | 157.55200 | −6.90533 | 1.11251 | 196.94000 | −7.42917 | 0.97933 |
| 113.58400 | −6.62327 | 1.53206 | 157.55200 | −5.89768 | 1.01241 | 196.94000 | −6.56639 | 0.92535 |
| 113.58400 | −5.26231 | 1.32031 | 157.55200 | −4.77928 | 0.90377 | 196.94000 | −5.60897 | 0.86679 |
| 113.58400 | −3.78320 | 1.08804 | 157.55200 | −3.56371 | 0.78396 | 196.94000 | −4.56839 | 0.80101 |
| 113.58400 | −2.20399 | 0.83331 | 157.55200 | −2.26554 | 0.65054 | 196.94000 | −3.45702 | 0.72557 |
| 113.58400 | −0.54493 | 0.55564 | 157.55200 | −0.90127 | 0.50219 | 196.94000 | −2.28888 | 0.63887 |
| 113.58400 | 1.17301 | 0.25443 | 157.55200 | 0.51207 | 0.33742 | 196.94000 | −1.07846 | 0.53919 |
| 113.58400 | 2.92693 | −0.06952 | 157.55200 | 1.95577 | 0.15582 | 196.94000 | 0.15831 | 0.42566 |
| 113.58400 | 4.69407 | −0.41478 | 157.55200 | 3.41125 | −0.04252 | 196.94000 | 1.40556 | 0.29785 |
| 113.58400 | 6.45011 | −0.77825 | 157.55200 | 4.85854 | −0.25622 | 196.94000 | 2.64624 | 0.15631 |
| 113.58400 | 8.17205 | −1.15683 | 157.55200 | 6.27875 | −0.48381 | 196.94000 | 3.86419 | 0.00178 |
| 113.58400 | 9.83561 | −1.54581 | 157.55200 | 7.65191 | −0.72261 | 196.94000 | 5.04229 | −0.16394 |
| 113.58400 | 11.41880 | −1.94067 | 157.55200 | 8.95985 | −0.96997 | 196.94000 | 6.16499 | −0.33900 |
| 113.58400 | 12.89910 | −2.33422 | 157.55200 | 10.18400 | −1.22109 | 196.94000 | 7.21634 | −0.51974 |
| 113.58400 | 14.25660 | −2.72046 | 157.55200 | 11.30780 | −1.47201 | 196.94000 | 8.18205 | −0.70312 |
| 113.58400 | 15.47220 | −3.09200 | 157.55200 | 12.31520 | −1.71762 | 196.94000 | 9.04844 | −0.88512 |
| 113.58400 | 16.52810 | −3.44111 | 157.55200 | 13.19160 | −1.95244 | 196.94000 | 9.80273 | −1.06147 |
| 113.58400 | 17.40920 | −3.76033 | 157.55200 | 13.92420 | −2.17112 | 196.94000 | 10.43390 | −1.22801 |
| 113.58400 | 18.09600 | −4.03990 | 157.55200 | 14.49670 | −2.36662 | 196.94000 | 10.92790 | −1.37913 |
| 113.58400 | 18.57650 | −4.25748 | 157.55200 | 14.89820 | −2.52130 | 196.94000 | 11.27490 | −1.49999 |
| 113.58400 | 18.85600 | −4.39288 | 157.55200 | 15.13230 | −2.61847 | 196.94000 | 11.47740 | −1.57628 |
| 113.58400 | 18.94730 | −4.43768 | 157.55200 | 15.20870 | −2.65068 | 196.94000 | 11.54360 | −1.60156 |

A direction x is a spanwise direction of a rotor, a direction y is a chord length direction of the rotor, a direction z is a thickness direction of the rotor, and k=a/229, where a is a radius value of the rotor. In an embodiment, the blade is vertically connected the hub. A radius of the blade equals to a radius of the rotor, and is a distance from a rotation center to the blade tip. For an integrated blade, the radius of the blade is half a length of the blade. Tables 1a and 1b show three-dimensional appearance data of an implementation of the blade for which a=229, that is, having a radius of 229 mm. It is to be understood that, families of curves obtained by scaling up or down the data also fall within the implementation scope of the present disclosure. A smooth transition is formed between the characteristic lines.

How to obtain, by surveying and mapping, a blade having a same appearance as the present disclosure in a case that the blade is selected to have another radius is exemplarily provided below. When the radius of the blade is 600 mm, that is, a=600, k=2.62009. Then, corresponding coordinate values in Tables 1a and 1b are multiplied by k, to obtain a new group of characteristic point coordinates of the characteristic lines. For example, the corresponding coordinates of the upper aerofoil characteristic line e in Table 1a are changed to (297.60030, −31.16505,7.31181), (297.60030, −30.85444,7.64422), . . . , and the corresponding coordinates of the lower aerofoil characteristic line e in Table 1b are changed to (297.60030, −31.16505, 7.31181), (297.60030, −31.01191, 6.97195) . . . .

A maximum error of each of the upper aerofoil characteristic line and the lower aerofoil characteristic line equals to ±3%, that is, shapes of wings formed by the upper aerofoil characteristic line and the lower aerofoil characteristic line within the permissible error range of ±3% all fall within the protection scope of the present disclosure.

It may be learned from the data in Tables 1a and 1b that, the blade 1 has a three-dimensional structure defined by the above three characteristic lines in an interval (that is, x is approximately in an interval of 113-196) relatively far from a center. A blade structure corresponding to the interval is a main structure in the blade, which is a relatively important pulling force generation region. By optimizing values of the characteristic lines in the region, a main portion of the blade 1 has optimal operating sections in a spanwise direction, so that air resistance can be reduced, and a pulling force and efficiency can be enhanced. In this way, the time of endurance of the rotor craft can be prolonged. In addition, noise generated during flight of the rotor craft can be reduced, thereby improving user experience.

In the present disclosure, the upper aerofoil characteristic line and the lower aerofoil characteristic line are further defined according to Tables 2a and 2b.

TABLE 2a
Characteristic point coordinates of upper aerofoil characteristic lines

| Upper aerofoil characteristic line a | | | Upper aerofoil characteristic line c | | |
|---|---|---|---|---|---|
| x | y | z | x | y | z |
| 27.02200 | −7.07713 | 0.49908 | 69.61600 | −12.09030 | 4.74961 |
| 27.02200 | −7.01481 | 0.76963 | 69.61600 | −11.90680 | 4.97008 |
| 27.02200 | −6.83677 | 1.14599 | 69.61600 | −11.45810 | 5.24879 |
| 27.02200 | −6.56299 | 1.49350 | 69.61600 | −10.82000 | 5.45316 |
| 27.02200 | −6.19305 | 1.81572 | 69.61600 | −9.99617 | 5.57229 |
| 27.02200 | −5.72909 | 2.10569 | 69.61600 | −8.99112 | 5.60440 |
| 27.02200 | −5.17425 | 2.34939 | 69.61600 | −7.81572 | 5.53415 |
| 27.02200 | −4.53228 | 2.54569 | 69.61600 | −6.47846 | 5.36066 |
| 27.02200 | −3.80924 | 2.69121 | 69.61600 | −4.99339 | 5.08143 |
| 27.02200 | −3.01166 | 2.78654 | 69.61600 | −3.37435 | 4.69860 |
| 27.02200 | −2.14868 | 2.83136 | 69.61600 | −1.64055 | 4.21519 |
| 27.02200 | −1.23007 | 2.82667 | 69.61600 | 0.18795 | 3.63622 |
| 27.02200 | −0.26707 | 2.77358 | 69.61600 | 2.08843 | 2.96825 |
| 27.02200 | 0.72880 | 2.67408 | 69.61600 | 4.03778 | 2.21894 |
| 27.02200 | 1.74469 | 2.52980 | 69.61600 | 6.01041 | 1.39686 |
| 27.02200 | 2.76808 | 2.34673 | 69.61600 | 7.98242 | 0.51494 |
| 27.02200 | 3.78508 | 2.12691 | 69.61600 | 9.92626 | −0.41699 |
| 27.02200 | 4.78262 | 1.87415 | 69.61600 | 11.81700 | −1.38654 |
| 27.02200 | 5.74702 | 1.59585 | 69.61600 | 13.62980 | −2.37594 |
| 27.02200 | 6.66607 | 1.30279 | 69.61600 | 15.34390 | −3.36427 |
| 27.02200 | 7.52705 | 1.00607 | 69.61600 | 16.93810 | −4.32862 |
| 27.02200 | 8.31897 | 0.72058 | 69.61600 | 18.39560 | −5.24305 |
| 27.02200 | 9.03081 | 0.45556 | 69.61600 | 19.69830 | −6.08745 |
| 27.02200 | 9.65203 | 0.21679 | 69.61600 | 20.82780 | −6.84579 |
| 27.02200 | 10.17300 | 0.00225 | 69.61600 | 21.76560 | −7.51165 |
| 27.02200 | 10.58200 | −0.18067 | 69.61600 | 22.49200 | −8.06558 |
| 27.02200 | 10.87100 | −0.30910 | 69.61600 | 23.00160 | −8.46590 |
| 27.02200 | 11.04090 | −0.37578 | 69.61600 | 23.30220 | −8.69468 |
| 27.02200 | 11.09660 | −0.39502 | 69.61600 | 23.40160 | −8.76687 |

TABLE 2b
Characteristic point coordinates of lower aerofoil characteristic lines

| Lower aerofoil characteristic line a | | | Lower aerofoil characteristic line c | | |
|---|---|---|---|---|---|
| x | y | z | x | y | z |
| 27.02200 | −7.07713 | 0.49908 | 69.61600 | −12.09030 | 4.74961 |
| 27.02200 | −7.05177 | 0.24103 | 69.61600 | −12.09140 | 4.49929 |
| 27.02200 | −6.92130 | −0.06296 | 69.61600 | −11.88030 | 4.17205 |
| 27.02200 | −6.68943 | −0.31464 | 69.61600 | −11.45140 | 3.84276 |
| 27.02200 | −6.35806 | −0.54396 | 69.61600 | −10.82020 | 3.47066 |
| 27.02200 | −5.92790 | −0.73756 | 69.61600 | −9.98396 | 3.07209 |
| 27.02200 | −5.40073 | −0.88938 | 69.61600 | −8.94667 | 2.64957 |
| 27.02200 | −4.78038 | −1.00236 | 69.61600 | −7.71741 | 2.20062 |
| 27.02200 | −4.07288 | −1.07907 | 69.61600 | −6.30995 | 1.72346 |
| 27.02200 | −3.28517 | −1.12477 | 69.61600 | −4.74015 | 1.21503 |
| 27.02200 | −2.42664 | −1.14365 | 69.61600 | −3.02859 | 0.67489 |
| 27.02200 | −1.50749 | −1.14058 | 69.61600 | −1.19739 | 0.10283 |
| 27.02200 | −0.53930 | −1.11947 | 69.61600 | 0.72900 | −0.49906 |
| 27.02200 | 0.46594 | −1.08495 | 69.61600 | 2.72516 | −1.12900 |
| 27.02200 | 1.49503 | −1.04048 | 69.61600 | 4.76370 | −1.78297 |
| 27.02200 | 2.53483 | −0.98889 | 69.61600 | 6.81757 | −2.45609 |
| 27.02200 | 3.57134 | −0.92963 | 69.61600 | 8.85864 | −3.14003 |
| 27.02200 | 4.59104 | −0.86559 | 69.61600 | 10.85960 | −3.82834 |
| 27.02200 | 5.57944 | −0.80069 | 69.61600 | 12.79180 | −4.51332 |
| 27.02200 | 6.52317 | −0.74081 | 69.61600 | 14.62860 | −5.18882 |
| 27.02200 | 7.40846 | −0.68990 | 69.61600 | 16.34350 | −5.84526 |
| 27.02200 | 8.22279 | −0.65489 | 69.61600 | 17.91220 | −6.47605 |
| 27.02200 | 8.95432 | −0.63829 | 69.61600 | 19.31250 | −7.07145 |
| 27.02200 | 9.59210 | −0.64025 | 69.61600 | 20.52400 | −7.62062 |
| 27.02200 | 10.12690 | −0.65643 | 69.61600 | 21.53050 | −8.11140 |
| 27.02200 | 10.54670 | −0.68635 | 69.61600 | 22.30970 | −8.53038 |
| 27.02200 | 10.84190 | −0.72583 | 69.61600 | 22.85000 | −8.85245 |
| 27.02200 | 11.01400 | −0.76079 | 69.61600 | 23.16150 | −9.05355 |
| 27.02200 | 11.07010 | −0.77410 | 69.61600 | 23.26290 | −9.12065 |

Since the blade root 16 is configured to be connected to the hub, the blade can rotate under driving of the driving assembly. Thus, an interval (that is, x is approximately in an interval of 27-69) relatively close to the center is selected to be optimized. In this case, the blade root 16 is closer to the hub than the main portion and the blade tip 17 of the blade 1, and therefore bears a higher torque. According to the present disclosure, thickening is performed in the interval, that is, on the blade root 16. That is to say, raised portions are formed outward in a chord direction of the blade root 16, to enhance the structural strength of the blade root 16.

In the present disclosure, the upper aerofoil characteristic line and the lower aerofoil characteristic line are further defined according to Tables 3a and 3b.

TABLE 3a
Characteristic point coordinates of upper aerofoil characteristic lines

| Upper aerofoil characteristic line d | | | Upper aerofoil characteristic line f | | | Upper aerofoil characteristic line h | | |
|---|---|---|---|---|---|---|---|---|
| x | y | z | x | y | z | x | y | z |
| 91.60000 | −12.35420 | 3.60535 | 135.56800 | −11.11360 | 2.20977 | 179.53600 | −10.36920 | 1.64138 |
| 91.60000 | −12.22030 | 3.76875 | 135.56800 | −11.02080 | 2.32767 | 179.53600 | −10.29720 | 1.74061 |
| 91.60000 | −11.85340 | 3.99201 | 135.56800 | −10.74320 | 2.50400 | 179.53600 | −10.07620 | 1.89346 |
| 91.60000 | −11.30490 | 4.17120 | 135.56800 | −10.31290 | 2.66124 | 179.53600 | −9.72995 | 2.03562 |
| 91.60000 | −10.57840 | 4.29269 | 135.56800 | −9.73236 | 2.78635 | 179.53600 | −9.26000 | 2.15635 |
| 91.60000 | −9.67707 | 4.35651 | 135.56800 | −9.00400 | 2.88011 | 179.53600 | −8.66838 | 2.25622 |
| 91.60000 | −8.60909 | 4.34979 | 135.56800 | −8.13334 | 2.93236 | 179.53600 | −7.95925 | 2.32676 |
| 91.60000 | −7.38220 | 4.27083 | 135.56800 | −7.12662 | 2.94107 | 179.53600 | −7.13764 | 2.36612 |
| 91.60000 | −6.00898 | 4.11626 | 135.56800 | −5.99388 | 2.90261 | 179.53600 | −6.21165 | 2.37100 |
| 91.60000 | −4.50242 | 3.88630 | 135.56800 | −4.74584 | 2.81596 | 179.53600 | −5.18998 | 2.34024 |
| 91.60000 | −2.88044 | 3.58175 | 135.56800 | −3.39724 | 2.68028 | 179.53600 | −4.08464 | 2.27267 |
| 91.60000 | −1.16195 | 3.20492 | 135.56800 | −1.96379 | 2.49583 | 179.53600 | −2.90847 | 2.16800 |
| 91.60000 | 0.63160 | 2.75943 | 135.56800 | −0.46334 | 2.26380 | 179.53600 | −1.67608 | 2.02663 |
| 91.60000 | 2.47829 | 2.24970 | 135.56800 | 1.08578 | 1.98589 | 179.53600 | −0.40249 | 1.84936 |
| 91.60000 | 4.35386 | 1.68093 | 135.56800 | 2.66330 | 1.66438 | 179.53600 | 0.89569 | 1.63741 |
| 91.60000 | 6.23539 | 1.06286 | 135.56800 | 4.24988 | 1.30615 | 179.53600 | 2.20257 | 1.39659 |
| 91.60000 | 8.09710 | 0.40284 | 135.56800 | 5.82407 | 0.91630 | 179.53600 | 3.50060 | 1.13114 |
| 91.60000 | 9.91496 | −0.29062 | 135.56800 | 7.36551 | 0.49962 | 179.53600 | 4.77300 | 0.84427 |
| 91.60000 | 11.66440 | −1.00466 | 135.56800 | 8.85305 | 0.06413 | 179.53600 | 6.00220 | 0.54168 |
| 91.60000 | 13.32420 | −1.72379 | 135.56800 | 10.26800 | −0.38013 | 179.53600 | 7.17257 | 0.23072 |
| 91.60000 | 14.87260 | −2.43067 | 135.56800 | 11.59100 | −0.82161 | 179.53600 | 8.26793 | −0.08010 |
| 91.60000 | 16.29140 | −3.10551 | 135.56800 | 12.80540 | −1.24695 | 179.53600 | 9.27424 | −0.38076 |
| 91.60000 | 17.56170 | −3.73304 | 135.56800 | 13.89470 | −1.64601 | 179.53600 | 10.17750 | −0.66390 |
| 91.60000 | 18.66540 | −4.30110 | 135.56800 | 14.84280 | −2.01093 | 179.53600 | 10.96440 | −0.92402 |
| 91.60000 | 19.58500 | −4.80514 | 135.56800 | 15.63510 | −2.33945 | 179.53600 | 11.62280 | −1.16011 |
| 91.60000 | 20.30040 | −5.23010 | 135.56800 | 16.25390 | −2.62150 | 179.53600 | 12.13800 | −1.36497 |
| 91.60000 | 20.80290 | −5.54059 | 135.56800 | 16.68920 | −2.83011 | 179.53600 | 12.50070 | −1.51722 |
| 91.60000 | 21.09810 | −5.71906 | 135.56800 | 16.94460 | −2.95034 | 179.53600 | 12.71340 | −1.60473 |
| 91.60000 | 21.19530 | −5.77537 | 135.56800 | 17.02840 | −2.98815 | 179.53600 | 12.78320 | −1.63209 |

TABLE 3b
Characteristic point coordinates of lower aerofoil characteristic lines

| Lower aerofoil characteristic line d | | | Lower aerofoil characteristic line f | | | Lower aerofoil characteristic line h | | |
|---|---|---|---|---|---|---|---|---|
| x | y | z | x | y | z | x | y | z |
| 91.60000 | −12.35420 | 3.60535 | 135.56800 | −11.11360 | 2.20977 | 179.53600 | −10.36920 | 1.64138 |
| 91.60000 | −12.31890 | 3.42979 | 135.56800 | −11.06710 | 2.09407 | 179.53600 | −10.32750 | 1.54842 |
| 91.60000 | −12.07910 | 3.21678 | 135.56800 | −10.84910 | 1.96974 | 179.53600 | −10.14550 | 1.45390 |
| 91.60000 | −11.64250 | 3.01175 | 135.56800 | −10.47130 | 1.86218 | 179.53600 | −9.83367 | 1.37819 |
| 91.60000 | −11.01890 | 2.77956 | 135.56800 | −9.93907 | 1.74355 | 179.53600 | −9.39536 | 1.29839 |
| 91.60000 | −10.20790 | 2.53330 | 135.56800 | −9.25308 | 1.62361 | 179.53600 | −8.83148 | 1.22245 |
| 91.60000 | −9.21378 | 2.27295 | 135.56800 | −8.41707 | 1.50107 | 179.53600 | −8.14504 | 1.14918 |
| 91.60000 | −8.04463 | 1.99567 | 135.56800 | −7.43744 | 1.37309 | 179.53600 | −7.34117 | 1.07608 |
| 91.60000 | −6.71290 | 1.69859 | 135.56800 | −6.32417 | 1.23643 | 179.53600 | −6.42793 | 1.00016 |
| 91.60000 | −5.23267 | 1.37821 | 135.56800 | −5.08848 | 1.08746 | 179.53600 | −5.41434 | 0.91812 |
| 91.60000 | −3.62258 | 1.03280 | 135.56800 | −3.74546 | 0.92363 | 179.53600 | −4.31266 | 0.82739 |
| 91.60000 | −1.90265 | 0.66095 | 135.56800 | −2.31133 | 0.74261 | 179.53600 | −3.13605 | 0.72555 |
| 91.60000 | −0.09524 | 0.26304 | 135.56800 | −0.80438 | 0.54337 | 179.53600 | −1.89940 | 0.61115 |
| 91.60000 | 1.77647 | −0.16075 | 135.56800 | 0.75648 | 0.32468 | 179.53600 | −0.61812 | 0.48262 |
| 91.60000 | 3.68728 | −0.60848 | 135.56800 | 2.35053 | 0.08658 | 179.53600 | 0.69089 | 0.33929 |
| 91.60000 | 5.61221 | −1.07751 | 135.56800 | 3.95720 | −0.17035 | 179.53600 | 2.01079 | 0.18099 |
| 91.60000 | 7.52477 | −1.56285 | 135.56800 | 5.55440 | −0.44408 | 179.53600 | 3.32351 | 0.00868 |
| 91.60000 | 9.39975 | −2.06013 | 135.56800 | 7.12127 | −0.73251 | 179.53600 | 4.61193 | −0.17661 |
| 91.60000 | 11.21060 | −2.56348 | 135.56800 | 8.63574 | −1.03214 | 179.53600 | 5.85794 | −0.37271 |
| 91.60000 | 12.93300 | −3.06766 | 135.56800 | 10.07780 | −1.33958 | 179.53600 | 7.04506 | −0.57752 |
| 91.60000 | 14.54250 | −3.56443 | 135.56800 | 11.42690 | −1.64904 | 179.53600 | 8.15641 | −0.78694 |
| 91.60000 | 16.01710 | −4.04740 | 135.56800 | 12.66490 | −1.95570 | 179.53600 | 9.17692 | −0.99765 |
| 91.60000 | 17.33610 | −4.50810 | 135.56800 | 13.77420 | −2.25350 | 179.53600 | 10.09210 | −1.20524 |
| 91.60000 | 18.48020 | −4.93749 | 135.56800 | 14.73870 | −2.53599 | 179.53600 | 10.88850 | −1.40497 |
| 91.60000 | 19.43330 | −5.32624 | 135.56800 | 15.54440 | −2.79693 | 179.53600 | 11.55460 | −1.59219 |
| 91.60000 | 20.17440 | −5.66302 | 135.56800 | 16.17330 | −3.02808 | 179.53600 | 12.07550 | −1.76076 |
| 91.60000 | 20.69130 | −5.92376 | 135.56800 | 16.61400 | −3.20967 | 179.53600 | 12.44110 | −1.89489 |
| 91.60000 | 20.99120 | −6.08626 | 135.56800 | 16.87070 | −3.32327 | 179.53600 | 12.65430 | −1.97941 |
| 91.60000 | 21.08910 | −6.14022 | 135.56800 | 16.95450 | −3.36090 | 179.53600 | 12.72390 | −2.00745 |

It may be learned that, in the present disclosure, the main portion of the blade 1 is further refined, so that the transition of the main portion of the blade 1 is smoother without sharp turns. Such a smooth transition structure can further enhance the entire structural strength of the blade 1, so that the blade is uneasily broken. Therefore, the reliability of the main portion of the blade 1 during operation can be enhanced, and a pulling force and efficiency can be higher.

In the present disclosure, the upper aerofoil characteristic line and the lower aerofoil characteristic line are further defined according to Table 4.

TABLE 4
Characteristic point coordinates of upper aerofoil characteristic lines and
lower aerofoil characteristic lines

| Upper aerofoil characteristic line b | | | Lower aerofoil characteristic line b | | |
|---|---|---|---|---|---|
| x | y | z | x | y | z |
| 48.31900 | −10.01800 | 1.99222 | 48.31900 | −10.01800 | 1.99222 |
| 48.31900 | −9.90122 | 2.24722 | 48.31900 | −10.00190 | 1.73932 |
| 48.31900 | −9.60006 | 2.59888 | 48.31900 | −9.83032 | 1.43726 |
| 48.31900 | −9.15774 | 2.91044 | 48.31900 | −9.50213 | 1.17308 |
| 48.31900 | −8.57465 | 3.17850 | 48.31900 | −9.02409 | 0.91120 |
| 48.31900 | −7.85424 | 3.39834 | 48.31900 | −8.39578 | 0.66641 |
| 48.31900 | −7.00283 | 3.55484 | 48.31900 | −7.61970 | 0.44287 |
| 48.31900 | −6.02629 | 3.64656 | 48.31900 | −6.70207 | 0.23742 |
| 48.31900 | −4.93423 | 3.66984 | 48.31900 | −5.65234 | 0.04716 |
| 48.31900 | −3.73656 | 3.62525 | 48.31900 | −4.48152 | −0.13293 |
| 48.31900 | −2.44713 | 3.51305 | 48.31900 | −3.20423 | −0.30633 |
| 48.31900 | −1.08061 | 3.33508 | 8.31900 | −1.83623 | −0.47685 |
| 48.31900 | 0.34625 | 3.09381 | 48.31900 | −0.39524 | −0.64683 |
| 48.31900 | 1.81632 | 2.79265 | 48.31900 | 1.10035 | −0.81921 |
| 48.31900 | 3.31055 | 2.43515 | 48.31900 | 2.63053 | −0.99534 |
| 48.31900 | 4.81076 | 2.02927 | 48.31900 | 4.17543 | −1.17586 |
| 48.31900 | 6.29639 | 1.57926 | 48.31900 | 5.71415 | −1.35802 |
| 48.31900 | 7.74841 | 1.09160 | 48.31900 | 7.22641 | −1.54175 |
| 48.31900 | 9.14728 | 0.57722 | 48.31900 | 8.69052 | −1.72703 |
| 48.31900 | 10.47610 | 0.05046 | 48.31900 | 10.08640 | −1.91546 |
| 48.31900 | 11.71730 | −0.47323 | 48.31900 | 11.39370 | −2.10604 |
| 48.31900 | 12.85640 | −0.97477 | 48.31900 | 12.59360 | −2.30058 |
| 48.31900 | 13.87820 | −1.44087 | 48.31900 | 13.66880 | −2.49704 |
| 48.31900 | 14.76780 | −1.86193 | 48.31900 | 14.60340 | −2.69148 |
| 48.31900 | 15.51110 | −2.23700 | 48.31900 | 15.38420 | −2.87680 |
| 48.31900 | 16.09170 | −2.55415 | 48.31900 | 15.99380 | −3.04763 |
| 48.31900 | 16.50100 | −2.78215 | 48.31900 | 16.42000 | −3.19068 |
| 48.31900 | 16.74220 | −2.90842 | 48.31900 | 16.66720 | −3.28677 |
| 48.31900 | 16.82160 | −2.94709 | 48.31900 | 16.74770 | −3.31983 |

It may be learned that, in the present disclosure, the region relatively close to the blade root 16 is further refined, so that the blade root 16 is smoother, thereby enhancing the structural strength of the blade 1.

Further, for more effective noise reduction, each section of the blade 1 of the present disclosure is required be in an optimal operating status in a spanwise direction, so that air resistance can be reduced, and a pulling force and efficiency can be enhanced. In this way, the time of endurance of the rotor craft can be prolonged. In addition, noise generated during flight of the rotor craft can be reduced, thereby improving user experience.

According to an implementation of the present disclosure, as shown in FIG. 1 and FIG. 2, a backswept portion 171 is further formed at the blade tip 17. The backswept portion 171 bends and extends from the front edge 11 to the tail edge 12. The upper aerofoil characteristic line and the lower aerofoil characteristic line of the backswept portion 171 are defined according to Tables 5a and 5b.

TABLE 5a
Characteristic point coordinates of upper aerofoil characteristic lines

| Upper aerofoil characteristic line j | | | Upper aerofoil characteristic line k | | |
|---|---|---|---|---|---|
| x | y | z | x | y | z |
| 209.76400 | −8.69407 | 0.91068 | 222.58800 | 0.09175 | −0.00367 |
| 209.76400 | −8.63887 | 0.98709 | 222.58800 | 0.12954 | 0.04671 |
| 209.76400 | −8.46076 | 1.11139 | 222.58800 | 0.25533 | 0.12543 |
| 209.76400 | −8.17652 | 1.23329 | 222.58800 | 0.45873 | 0.20185 |
| 209.76400 | −7.78691 | 1.34340 | 222.58800 | 0.73962 | 0.27185 |
| 209.76400 | −7.29365 | 1.44242 | 222.58800 | 1.09669 | 0.33536 |
| 209.76400 | −6.69984 | 1.52350 | 222.58800 | 1.52795 | 0.38844 |
| 209.76400 | −6.00963 | 1.58489 | 222.58800 | 2.03043 | 0.43021 |
| 209.76400 | −5.22969 | 1.62357 | 222.58800 | 2.59938 | 0.45907 |
| 209.76400 | −4.36731 | 1.63811 | 222.58800 | 3.22956 | 0.47437 |
| 209.76400 | −3.43256 | 1.62702 | 222.58800 | 3.91364 | 0.47537 |
| 209.76400 | −2.43627 | 1.58944 | 222.58800 | 4.64378 | 0.46168 |
| 209.76400 | −1.39077 | 1.52501 | 222.58800 | 5.41097 | 0.43317 |
| 209.76400 | −0.30877 | 1.43367 | 222.58800 | 6.20592 | 0.38986 |
| 209.76400 | 0.79565 | 1.31566 | 222.58800 | 7.01835 | 0.33191 |
| 209.76400 | 1.90892 | 1.17583 | 222.58800 | 7.83826 | 0.26397 |
| 209.76400 | 3.01612 | 1.01776 | 222.58800 | 8.65473 | 0.18991 |
| 209.76400 | 4.10294 | 0.84321 | 222.58800 | 9.45722 | 0.11046 |
| 209.76400 | 5.15428 | 0.65580 | 222.58800 | 10.23450 | 0.02720 |
| 209.76400 | 6.15655 | 0.46042 | 222.58800 | 10.97640 | −0.05772 |
| 209.76400 | 7.09567 | 0.26284 | 222.58800 | 11.67240 | −0.14191 |
| 209.76400 | 7.95927 | 0.07003 | 222.58800 | 12.31310 | −0.22234 |
| 209.76400 | 8.73515 | −0.11313 | 222.58800 | 12.88920 | −0.29732 |
| 209.76400 | 9.41175 | −0.28318 | 222.58800 | 13.39230 | −0.36609 |
| 209.76400 | 9.97877 | −0.44012 | 222.58800 | 13.81450 | −0.42982 |
| 209.76400 | 10.42340 | −0.57914 | 222.58800 | 14.14640 | −0.48707 |
| 209.76400 | 10.73680 | −0.68372 | 222.58800 | 14.38060 | −0.52996 |
| 209.76400 | 10.92050 | −0.74384 | 222.58800 | 14.51790 | −0.55392 |
| 209.76400 | 10.98070 | −0.76252 | 222.58800 | 14.56290 | −0.56114 |

TABLE 5b
Characteristic point coordinates of lower aerofoil characteristic lines

| Lower aerofoil characteristic line j | | | Lower aerofoil characteristic line k | | |
|---|---|---|---|---|---|
| x | y | z | x | y | z |
| 209.76400 | −8.69407 | 0.91068 | 222.58800 | 0.09175 | −0.00367 |
| 209.76400 | −8.65377 | 0.84410 | 222.58800 | 0.12338 | −0.04848 |
| 209.76400 | −8.49485 | 0.78437 | 222.58800 | 0.24125 | −0.09226 |
| 209.76400 | −8.22750 | 0.74418 | 222.58800 | 0.43767 | −0.12373 |
| 209.76400 | −7.85344 | 0.70510 | 222.58800 | 0.71214 | −0.15304 |
| 209.76400 | −7.37382 | 0.67331 | 222.58800 | 1.06358 | −0.17661 |
| 209.76400 | −6.79116 | 0.64740 | 222.58800 | 1.49023 | −0.19475 |
| 209.76400 | −6.10967 | 0.62513 | 222.58800 | 1.98910 | −0.20867 |
| 209.76400 | −5.33600 | 0.60369 | 222.58800 | 2.55547 | −0.21982 |
| 209.76400 | −4.47759 | 0.58009 | 222.58800 | 3.18400 | −0.22992 |
| 209.76400 | −3.54464 | 0.55177 | 222.58800 | 3.86734 | −0.24039 |
| 209.76400 | −2.54813 | 0.51629 | 222.58800 | 4.59757 | −0.25267 |
| 209.76400 | −1.50054 | 0.47193 | 222.58800 | 5.36562 | −0.26783 |
| 209.76400 | −0.41476 | 0.41684 | 222.58800 | 6.16214 | −0.28700 |
| 209.76400 | 0.69499 | 0.34989 | 222.58800 | 6.97677 | −0.31097 |
| 209.76400 | 1.81453 | 0.27030 | 222.58800 | 7.79918 | −0.34031 |
| 209.76400 | 2.92859 | 0.17805 | 222.58800 | 8.61819 | −0.37503 |
| 209.76400 | 4.02270 | 0.07343 | 222.58800 | 9.42321 | −0.41525 |
| 209.76400 | 5.08150 | −0.04237 | 222.58800 | 10.20290 | −0.46067 |
| 209.76400 | 6.09105 | −0.16799 | 222.58800 | 10.94710 | −0.51107 |
| 209.76400 | 7.03695 | −0.30051 | 222.58800 | 11.64500 | −0.56537 |
| 209.76400 | 7.90637 | −0.43745 | 222.58800 | 12.28720 | −0.62289 |
| 209.76400 | 8.68695 | −0.57555 | 222.58800 | 12.86430 | −0.68231 |
| 209.76400 | 9.36712 | −0.71137 | 222.58800 | 13.36790 | −0.74210 |
| 209.76400 | 9.93692 | −0.84160 | 222.58800 | 13.79050 | −0.80055 |
| 209.76400 | 10.38350 | −0.96166 | 222.58800 | 14.12250 | −0.85557 |
| 209.76400 | 10.69770 | −1.05867 | 222.58800 | 14.35660 | −0.90106 |
| 209.76400 | 10.88130 | −1.12012 | 222.58800 | 14.49360 | −0.93050 |
| 209.76400 | 10.94130 | −1.14047 | 222.58800 | 14.53830 | −0.94034 |

A direction x is a spanwise direction of a rotor, a direction y is a chord length direction of the rotor, a direction z is a thickness direction of the rotor, and k=a/229, where a is a radius value of the rotor. Tables 5a and 5b show three-dimensional appearance data of an implementation of the blade for which a=229, that is, having a radius of 229 mm. It is to be understood that, families of curves obtained by scaling up or down the data also fall within the implementation scope of the present disclosure. A smooth transition is formed between the characteristic lines.

How to obtain a backswept portion 171 having a same appearance as the present disclosure in a case that the blade is selected to have another radius is exemplarily provided below. For example, when the radius of the blade is 600 mm, that is, a=600, k=2.62009. Then, corresponding coordinate values in Tables 5a and 5b are multiplied by k, to obtain a new group of characteristic point coordinates of the characteristic lines. For example, the corresponding coordinates of the upper aerofoil characteristic line j in Table 5a are changed to (549.60056, −22.77924,2.38606), (549.60056, −22.77924,2.58626), . . . , and the corresponding coordinates of the lower aerofoil characteristic line j in Table 5b are changed to (549.60056, −22.77924,2.38606), (549.60056, −22.67366,2.21162) . . . .

A maximum error of each of the upper aerofoil characteristic line and the lower aerofoil characteristic line equals to ±3%, that is, shapes of wings formed by the upper aerofoil characteristic line and the lower aerofoil characteristic line within the permissible error range of ±3% all fall within the protection scope of the present disclosure.

In the present disclosure, the three-dimensional structure formed by the above two aerofoil characteristic lines has the backswept portion 171. The backswept portion 171 can cut off spanwise flowing of air above the blade 1 during rotation of the blade 1. Therefore, vortexes formed at the blade tip 17 can be reduced, and the strength of the vortexes at the blade tip 17 can be reduced. In addition, the backswept portion 171 can reduce a variability of change of an air pressure near the blade 1, so that periodic cutting of airflows by the blade 1 having a specific thickness can be reduced, thereby reducing rotation noise generated during the rotation of the blade 1.

For more desirable performance of the backswept portion, the present disclosure further adds an aerofoil characteristic line to define the backswept portion. Details are shown in Table 6.

TABLE 6
Characteristic point coordinates of upper aerofoil characteristic lines and
lower aerofoil characteristic lines

| Upper aerofoil characteristic line l | | | Lower aerofoil characteristic line l | | |
|---|---|---|---|---|---|
| x | y | z | x | y | z |
| 228.83000 | 8.82439 | −0.38479 | 228.83000 | 8.82439 | −0.38479 |
| 228.82900 | 8.85115 | −0.35168 | 228.82900 | 8.84826 | −0.41795 |
| 228.82500 | 8.94159 | −0.30742 | 228.82600 | 8.93497 | −0.45898 |
| 228.82000 | 9.08881 | −0.26856 | 228.82000 | 9.07891 | −0.49524 |
| 228.81100 | 9.29294 | −0.23455 | 228.81200 | 9.28002 | −0.53038 |
| 228.80100 | 9.55299 | −0.20627 | 228.80100 | 9.53742 | −0.56272 |
| 228.78700 | 9.86760 | −0.18539 | 228.78800 | 9.84987 | −0.59143 |
| 228.77100 | 10.23470 | −0.17199 | 228.77200 | 10.21520 | −0.61680 |
| 228.75200 | 10.65070 | −0.16635 | 228.75300 | 10.63010 | −0.63902 |
| 228.73000 | 11.11200 | −0.16827 | 228.73100 | 11.09060 | −0.65862 |
| 228.70500 | 11.61310 | −0.17761 | 228.70600 | 11.59140 | −0.67595 |
| 228.67800 | 12.14840 | −0.19407 | 228.67900 | 12.12670 | −0.69144 |
| 228.64700 | 12.71130 | −0.21729 | 228.64800 | 12.69000 | −0.70536 |
| 228.61400 | 13.29500 | −0.24682 | 228.61500 | 13.27440 | −0.71809 |
| 228.57800 | 13.89190 | −0.28222 | 228.57900 | 13.87240 | −0.72982 |
| 228.54100 | 14.49480 | −0.31860 | 228.54200 | 14.47630 | −0.74069 |
| 228.50200 | 15.09550 | −0.35161 | 228.50300 | 15.07810 | −0.75037 |
| 228.46200 | 15.68640 | −0.38094 | 228.46300 | 15.66990 | −0.75900 |
| 228.42200 | 16.25920 | −0.40623 | 228.42300 | 16.24350 | −0.76685 |
| 228.38200 | 16.80640 | −0.42707 | 228.38400 | 16.79120 | −0.77445 |
| 228.34400 | 17.32000 | −0.44337 | 228.34500 | 17.30520 | −0.78211 |
| 228.30800 | 17.79310 | −0.45480 | 228.30900 | 17.77840 | −0.79052 |
| 228.27400 | 18.21880 | −0.46189 | 228.27500 | 18.20400 | −0.79984 |
| 228.24400 | 18.59070 | −0.46571 | 228.24500 | 18.57570 | −0.80993 |
| 228.21800 | 18.90330 | −0.46825 | 228.22000 | 18.88790 | −0.82010 |
| 228.19800 | 19.14920 | −0.47040 | 228.19900 | 19.13350 | −0.83012 |
| 228.18300 | 19.32300 | −0.47097 | 228.18500 | 19.30690 | −0.83942 |
| 228.17500 | 19.42480 | −0.46991 | 228.17600 | 19.40840 | −0.84634 |
| 228.17200 | 19.45820 | −0.46920 | 228.17300 | 19.44160 | −0.84884 |

By further defining the upper aerofoil characteristic line and the lower aerofoil characteristic line of the backswept portion 171, the backswept portion 171 is smoother, so that the vortexes formed at the blade tip 17 are more stable, thereby reducing noise more effectively.

The beneficial effects of the blade 1 of the present disclosure for enhancing the aerodynamic efficiency of the rotor craft are further described below by using a motor efficiency comparison test of the blade (made of 18-inch bakelite) of the present disclosure and a T-motor pure carbon blade.

As shown in FIG. 3, the motor efficiency of the rotor craft using the blade 1 of the present disclosure is averagely increased by 4.9% compared with that of the T-motor pure carbon blade. Specifically, under a pulling force of 1.5 kg, the motor efficiency is enhanced by 2.7%. Under a pulling force of 1.1 kg, the motor efficiency is enhanced by 5%. Under a pulling force of 1.8 kg, the motor efficiency is enhanced by 7%. In addition, it is learned by means of an experiment and a numerical simulation that the noise of the blade 1 of the present disclosure is 3 dB lower than that of the T-motor pure carbon blade. Accuracy of an experimental result of the motor efficiency test of the present disclosure is ensured by means of a numerical simulation and a wind tunnel experiment.

According to an implementation of the present disclosure, as shown in FIG. 2, the blade includes at least two blades 1. The at least two blades 1 are connected to each other by using the blade root 16, and are symmetrical about a central point of a joint between the blade roots 16 of the at least two blades 1. The at least two blades 1 may be integrally formed, to ensure the entire structural strength of the blades 1. Alternatively, the blades 1 may be separately formed. For example, each blade 1 is mounted to the hub, so that the blade 1 can be relatively conveniently mounted and replaced. In this case, the rotation center of the blade 1 is an axis where the hub is located.

The present disclosure further provides a rotor craft. The rotor craft includes the foregoing blade. The rotor craft may be a multi-rotor craft. The rotor craft has all of the beneficial effects of the rotor of the above rotor craft. Details are not described herein again.

The exemplary embodiments of the present disclosure are described in detail above with reference to the accompanying drawings. However, the present disclosure is not limited to the specific details in the foregoing implementations, a plurality of simple deformations may be made to the technical solution of the present disclosure within a range of the technical concept of the present disclosure, and these simple deformations fall within the protection scope of the present disclosure.

It should be additionally noted that, the specific technical features described in the foregoing specific implementations may be combined in any proper manner in a case without conflict. To avoid unnecessary repetition, various possible combination manners are not described in the present disclosure.

In addition, different implementations of the present disclosure may also be arbitrarily combined without departing from the idea of the present disclosure, and these combinations shall still be regarded as content disclosed in the present disclosure.

1. A blade of a rotor craft, the blade comprising a blade root (16), a blade tip (17), and an upper aerofoil (18) and a lower aerofoil (19) disposed vertically opposite to each other, wherein one sides of the upper aerofoil (18) and the lower aerofoil (19) are connected to form a front edge (11), other sides of the upper aerofoil and the lower aerofoil are connected to form a tail edge (12), the upper aerofoil (18) is defined by an upper aerofoil characteristic line formed by (kx, ky, kz) defined by a plurality of coordinate pairs (x, y, z), the lower aerofoil (19) is defined by a lower aerofoil characteristic line formed by (kx, ky, kz) defined by a plurality of coordinate pairs (x, y, z), and the upper aerofoil characteristic line and the lower aerofoil characteristic line are defined according to following tables:

| Upper aerofoil characteristic line e | | | Upper aerofoil characteristic line g | | | Upper aerofoil characteristic line j | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.77610 | 2.91754 | 157.55200 | −10.15950 | 1.89922 | 196.94000 | −10.23250 | 1.52494 |
| 113.58400 | −11.46230 | 3.10200 | 157.55200 | −9.91255 | 2.06417 | 196.94000 | −10.02740 | 1.66809 |
| 113.58400 | −10.98050 | 3.25954 | 157.55200 | −9.52751 | 2.21508 | 196.94000 | −9.70404 | 1.80392 |
| 113.58400 | −10.33370 | 3.37583 | 157.55200 | −9.00615 | 2.34012 | 196.94000 | −9.26354 | 1.92207 |
| 113.58400 | −9.52457 | 3.45183 | 157.55200 | −8.35072 | 2.43996 | 196.94000 | −8.70785 | 2.02317 |
| 113.58400 | −8.55966 | 3.47650 | 157.55200 | −7.56599 | 2.50530 | 196.94000 | −8.04075 | 2.09930 |
| 113.58400 | −7.44593 | 3.44784 | 157.55200 | −6.65755 | 2.53419 | 196.94000 | −7.26694 | 2.14861 |
| 113.58400 | −6.19462 | 3.36224 | 157.55200 | −5.63438 | 2.52314 | 196.94000 | −6.39400 | 2.16788 |
| 113.58400 | −4.81762 | 3.21894 | 157.55200 | −4.50614 | 2.47100 | 196.94000 | −5.43013 | 2.15579 |
| 113.58400 | −3.33128 | 3.01760 | 157.55200 | −3.28611 | 2.37672 | 196.94000 | −4.38664 | 2.11101 |
| 113.58400 | −1.75295 | 2.75910 | 157.55200 | −1.98849 | 2.24019 | 196.94000 | −3.27562 | 2.03301 |
| 113.58400 | −0.10233 | 2.44542 | 157.55200 | −0.62940 | 2.06210 | 196.94000 | −2.11088 | 1.92186 |
| 113.58400 | 1.60038 | 2.07915 | 157.55200 | 0.77458 | 1.84363 | 196.94000 | −0.90659 | 1.77801 |
| 113.58400 | 3.33284 | 1.66357 | 157.55200 | 2.20510 | 1.58640 | 196.94000 | 0.32155 | 1.60228 |
| 113.58400 | 5.07381 | 1.20659 | 157.55200 | 3.64465 | 1.29665 | 196.94000 | 1.55849 | 1.40008 |
| 113.58400 | 6.79966 | 0.71417 | 157.55200 | 5.07381 | 0.97894 | 196.94000 | 2.78763 | 1.17540 |
| 113.58400 | 8.48807 | 0.19246 | 157.55200 | 6.47412 | 0.63715 | 196.94000 | 3.99309 | 0.93087 |
| 113.58400 | 10.11600 | −0.34878 | 157.55200 | 7.82630 | 0.27797 | 196.94000 | 5.15819 | 0.67142 |
| 113.58400 | 11.66310 | −0.89760 | 157.55200 | 9.11321 | −0.09004 | 196.94000 | 6.26801 | 0.40352 |
| 113.58400 | 13.10850 | −1.44033 | 157.55200 | 10.31720 | −0.45705 | 196.94000 | 7.30713 | 0.13467 |
| 113.58400 | 14.43440 | −1.96134 | 157.55200 | 11.42290 | −0.81150 | 196.94000 | 8.26209 | −0.12618 |
| 113.58400 | 15.62290 | −2.44856 | 157.55200 | 12.41510 | −1.14480 | 196.94000 | 9.11955 | −0.37258 |
| 113.58400 | 16.65660 | −2.89249 | 157.55200 | 13.27910 | −1.45043 | 196.94000 | 9.86679 | −0.59975 |
| 113.58400 | 17.51940 | −3.28980 | 157.55200 | 14.00170 | −1.72682 | 196.94000 | 10.49230 | −0.80704 |
| 113.58400 | 18.19240 | −3.62849 | 157.55200 | 14.56660 | −1.96550 | 196.94000 | 10.98220 | −0.98811 |
| 113.58400 | 18.66530 | −3.87812 | 157.55200 | 14.96430 | −2.14251 | 196.94000 | 11.32720 | −1.12323 |
| 113.58400 | 18.94280 | −4.02223 | 157.55200 | 15.19750 | −2.24439 | 196.94000 | 11.52950 | −1.20092 |
| 113.58400 | 19.03400 | −4.06770 | 157.55200 | 15.27400 | −2.27632 | 196.94000 | 11.59580 | −1.22517 |
| Lower aerofoil characteristic line e | | | Lower aerofoil characteristic line g | | | Lower aerofoil characteristic line j | | |
|---|---|---|---|---|---|---|---|---|
| x | y | z | x | y | z | x | y | z |
| 113.58400 | −11.88320 | 2.79067 | 157.55200 | −10.24080 | 1.79086 | 196.94000 | −10.29820 | 1.43389 |
| 113.58400 | −11.83620 | 2.66095 | 157.55200 | −10.19640 | 1.68741 | 196.94000 | −10.25670 | 1.35074 |
| 113.58400 | −11.59980 | 2.51515 | 157.55200 | −9.99698 | 1.57975 | 196.94000 | −10.08270 | 1.26967 |
| 113.58400 | −11.18610 | 2.38183 | 157.55200 | −9.65378 | 1.49057 | 196.94000 | −9.78671 | 1.20803 |
| 113.58400 | −10.60200 | 2.23039 | 157.55200 | −9.17094 | 1.39461 | 196.94000 | −9.37143 | 1.14442 |
| 113.58400 | −9.84782 | 2.07165 | 157.55200 | −8.54928 | 1.30069 | 196.94000 | −8.83785 | 1.08615 |
| 113.58400 | −8.92789 | 1.90433 | 157.55200 | −7.79218 | 1.20755 | 196.94000 | −8.18883 | 1.03194 |
| 113.58400 | −7.84931 | 1.72554 | 157.55200 | −6.90533 | 1.11251 | 196.94000 | −7.42917 | 0.97933 |
| 113.58400 | −6.62327 | 1.53206 | 157.55200 | −5.89768 | 1.01241 | 196.94000 | −6.56639 | 0.92535 |
| 113.58400 | −5.26231 | 1.32031 | 157.55200 | −4.77928 | 0.90377 | 196.94000 | −5.60897 | 0.86679 |
| 113.58400 | −3.78320 | 1.08804 | 157.55200 | −3.56371 | 0.78396 | 196.94000 | −4.56839 | 0.80101 |
| 113.58400 | −2.20399 | 0.83331 | 157.55200 | −2.26554 | 0.65054 | 196.94000 | −3.45702 | 0.72557 |
| 113.58400 | −0.54493 | 0.55564 | 157.55200 | −0.90127 | 0.50219 | 196.94000 | −2.28888 | 0.63887 |
| 113.58400 | 1.17301 | 0.25443 | 157.55200 | 0.51207 | 0.33742 | 196.94000 | −1.07846 | 0.53919 |
| 113.58400 | 2.92693 | −0.06952 | 157.55200 | 1.95577 | 0.15582 | 196.94000 | 0.15831 | 0.42566 |
| 113.58400 | 4.69407 | −0.41478 | 157.55200 | 3.41125 | −0.04252 | 196.94000 | 1.40556 | 0.29785 |
| 113.58400 | 6.45011 | −0.77825 | 157.55200 | 4.85854 | −0.25622 | 196.94000 | 2.64624 | 0.15631 |
| 113.58400 | 8.17205 | −1.15683 | 157.55200 | 6.27875 | −0.48381 | 196.94000 | 3.86419 | 0.00178 |
| 113.58400 | 9.83561 | −1.54581 | 157.55200 | 7.65191 | −0.72261 | 196.94000 | 5.04229 | −0.16394 |
| 113.58400 | 11.41880 | −1.94067 | 157.55200 | 8.95985 | −0.96997 | 196.94000 | 6.16499 | −0.33900 |
| 113.58400 | 12.89910 | −2.33422 | 157.55200 | 10.18400 | −1.22109 | 196.94000 | 7.21634 | −0.51974 |
| 113.58400 | 14.25660 | −2.72046 | 157.55200 | 11.30780 | −1.47201 | 196.94000 | 8.18205 | −0.70312 |
| 113.58400 | 15.47220 | −3.09200 | 157.55200 | 12.31520 | −1.71762 | 196.94000 | 9.04844 | −0.88512 |
| 113.58400 | 16.52810 | −3.44111 | 157.55200 | 13.19160 | −1.95244 | 196.94000 | 9.80273 | −1.06147 |
| 113.58400 | 17.40920 | −3.76033 | 157.55200 | 13.92420 | −2.17112 | 196.94000 | 10.43390 | −1.22801 |
| 113.58400 | 18.09600 | −4.03990 | 157.55200 | 14.49670 | −2.36662 | 196.94000 | 10.92790 | −1.37913 |
| 113.58400 | 18.57650 | −4.25748 | 157.55200 | 14.89820 | −2.52130 | 196.94000 | 11.27490 | −1.49999 |
| 113.58400 | 18.85600 | −4.39288 | 157.55200 | 15.13230 | −2.61847 | 196.94000 | 11.47740 | −1.57628 |
| 113.58400 | 18.94730 | −4.43768 | 157.55200 | 15.20870 | −2.65068 | 196.94000 | 11.54360 | −1.60156 |

wherein a direction x is a spanwise direction of a rotor, a direction y is a chord length direction of the rotor, a direction z is a thickness direction of the rotor, and k=a/229, wherein a is a radius value of the rotor, and a maximum error of each of the upper aerofoil characteristic line and the lower aerofoil characteristic line equals to ±3%.

2. The blade of a rotor craft according to claim 1, wherein the upper aerofoil characteristic line and the lower aerofoil characteristic line are further defined according to following tables:

| Upper aerofoil characteristic line a | | | Upper aerofoil characteristic line c | | |
|---|---|---|---|---|---|
| x | y | z | x | y | z |
| 27.02200 | −7.07713 | 0.49908 | 69.61600 | −12.09030 | 4.74961 |
| 27.02200 | −7.01481 | 0.76963 | 69.61600 | −11.90680 | 4.97008 |
| 27.02200 | −6.83677 | 1.14599 | 69.61600 | −11.45810 | 5.24879 |
| 27.02200 | −6.56299 | 1.49350 | 69.61600 | −10.82000 | 5.45316 |
| 27.02200 | −6.19305 | 1.81572 | 69.61600 | −9.99617 | 5.57229 |
| 27.02200 | −5.72909 | 2.10569 | 69.61600 | −8.99112 | 5.60440 |
| 27.02200 | −5.17425 | 2.34939 | 69.61600 | −7.81572 | 5.53415 |
| 27.02200 | −4.53228 | 2.54569 | 69.61600 | −6.47846 | 5.36066 |
| 27.02200 | −3.80924 | 2.69121 | 69.61600 | −4.99339 | 5.08143 |
| 27.02200 | −3.01166 | 2.78654 | 69.61600 | −3.37435 | 4.69860 |
| 27.02200 | −2.14868 | 2.83136 | 69.61600 | −1.64055 | 4.21519 |
| 27.02200 | −1.23007 | 2.82667 | 69.61600 | 0.18795 | 3.63622 |
| 27.02200 | −0.26707 | 2.77358 | 69.61600 | 2.08843 | 2.96825 |
| 27.02200 | 0.72880 | 2.67408 | 69.61600 | 4.03778 | 2.21894 |
| 27.02200 | 1.74469 | 2.52980 | 69.61600 | 6.01041 | 1.39686 |
| 27.02200 | 2.76808 | 2.34673 | 69.61600 | 7.98242 | 0.51494 |
| 27.02200 | 3.78508 | 2.12691 | 69.61600 | 9.92626 | −0.41699 |
| 27.02200 | 4.78262 | 1.87415 | 69.61600 | 11.81700 | −1.38654 |
| 27.02200 | 5.74702 | 1.59585 | 69.61600 | 13.62980 | −2.37594 |
| 27.02200 | 6.66607 | 1.30279 | 69.61600 | 15.34390 | −3.36427 |
| 27.02200 | 7.52705 | 1.00607 | 69.61600 | 16.93810 | −4.32862 |
| 27.02200 | 8.31897 | 0.72058 | 69.61600 | 18.39560 | −5.24305 |
| 27.02200 | 9.03081 | 0.45556 | 69.61600 | 19.69830 | −6.08745 |
| 27.02200 | 9.65203 | 0.21679 | 69.61600 | 20.82780 | −6.84579 |
| 27.02200 | 10.17300 | 0.00225 | 69.61600 | 21.76560 | −7.51165 |
| 27.02200 | 10.58200 | −0.18067 | 69.61600 | 22.49200 | −8.06558 |
| 27.02200 | 10.87100 | −0.30910 | 69.61600 | 23.00160 | −8.46590 |
| 27.02200 | 11.04090 | −0.37578 | 69.61600 | 23.30220 | −8.69468 |
| 27.02200 | 11.09660 | −0.39502 | 69.61600 | 23.40160 | −8.76687 |
| Lower aerofoil characteristic line a | | | Lower aerofoil characteristic line c | | |
|---|---|---|---|---|---|
| x | y | z | x | y | z |
| 27.02200 | −7.07713 | 0.49908 | 69.61600 | −12.09030 | 4.74961 |
| 27.02200 | −7.05177 | 0.24103 | 69.61600 | −12.09140 | 4.49929 |
| 27.02200 | −6.92130 | −0.06296 | 69.61600 | −11.88030 | 4.17205 |
| 27.02200 | −6.68943 | −0.31464 | 69.61600 | −11.45140 | 3.84276 |
| 27.02200 | −6.35806 | −0.54396 | 69.61600 | −10.82020 | 3.47066 |
| 27.02200 | −5.92790 | −0.73756 | 69.61600 | −9.98396 | 3.07209 |
| 27.02200 | −5.40073 | −0.88938 | 69.61600 | −8.94667 | 2.64957 |
| 27.02200 | −4.78038 | −1.00236 | 69.61600 | −7.71741 | 2.20062 |
| 27.02200 | −4.07288 | −1.07907 | 69.61600 | −6.30995 | 1.72346 |
| 27.02200 | −3.28517 | −1.12477 | 69.61600 | −4.74015 | 1.21503 |
| 27.02200 | −2.42664 | −1.14365 | 69.61600 | −3.02859 | 0.67489 |
| 27.02200 | −1.50749 | −1.14058 | 69.61600 | −1.19739 | 0.10283 |
| 27.02200 | −0.53930 | −1.11947 | 69.61600 | 0.72900 | −0.49906 |
| 27.02200 | 0.46594 | −1.08495 | 69.61600 | 2.72516 | −1.12900 |
| 27.02200 | 1.49503 | −1.04048 | 69.61600 | 4.76370 | −1.78297 |
| 27.02200 | 2.53483 | −0.98889 | 69.61600 | 6.81757 | −2.45609 |
| 27.02200 | 3.57134 | −0.92963 | 69.61600 | 8.85864 | −3.14003 |
| 27.02200 | 4.59104 | −0.86559 | 69.61600 | 10.85960 | −3.82834 |
| 27.02200 | 5.57944 | −0.80069 | 69.61600 | 12.79180 | −4.51332 |
| 27.02200 | 6.52317 | −0.74081 | 69.61600 | 14.62860 | −5.18882 |
| 27.02200 | 7.40846 | −0.68990 | 69.61600 | 16.34350 | −5.84526 |
| 27.02200 | 8.22279 | −0.65489 | 69.61600 | 17.91220 | −6.47605 |
| 27.02200 | 8.95432 | −0.63829 | 69.61600 | 19.31250 | −7.07145 |
| 27.02200 | 9.59210 | −0.64025 | 69.61600 | 20.52400 | −7.62062 |
| 27.02200 | 10.12690 | −0.65643 | 69.61600 | 21.53050 | −8.11140 |
| 27.02200 | 10.54670 | −0.68635 | 69.61600 | 22.30970 | −8.53038 |
| 27.02200 | 10.84190 | −0.72583 | 69.61600 | 22.85000 | −8.85245 |
| 27.02200 | 11.01400 | −0.76079 | 69.61600 | 23.16150 | −9.05355 |
| 27.02200 | 11.07010 | −0.77410 | 69.61600 | 23.26290 | −9.12065. |

3. The blade of a rotor craft according to claim 2, wherein the upper aerofoil characteristic line and the lower aerofoil characteristic line are further defined according to following tables:

| Upper aerofoil characteristic line d | | | Upper aerofoil characteristic line f | | | Upper aerofoil characteristic line h | | |
|---|---|---|---|---|---|---|---|---|
| x | y | z | x | y | z | x | y | z |
| 91.60000 | −12.35420 | 3.60535 | 135.56800 | −11.11360 | 2.20977 | 179.53600 | −10.36920 | 1.64138 |
| 91.60000 | −12.22030 | 3.76875 | 135.56800 | −11.02080 | 2.32767 | 179.53600 | −10.29720 | 1.74061 |
| 91.60000 | −11.85340 | 3.99201 | 135.56800 | −10.74320 | 2.50400 | 179.53600 | −10.07620 | 1.89346 |
| 91.60000 | −11.30490 | 4.17120 | 135.56800 | −10.31290 | 2.66124 | 179.53600 | −9.72995 | 2.03562 |
| 91.60000 | −10.57840 | 4.29269 | 135.56800 | −9.73236 | 2.78635 | 179.53600 | −9.26000 | 2.15635 |
| 91.60000 | −9.67707 | 4.35651 | 135.56800 | −9.00400 | 2.88011 | 179.53600 | −8.66838 | 2.25622 |
| 91.60000 | −8.60909 | 4.34979 | 135.56800 | −8.13334 | 2.93236 | 179.53600 | −7.95925 | 2.32676 |
| 91.60000 | −7.38220 | 4.27083 | 135.56800 | −7.12662 | 2.94107 | 179.53600 | −7.13764 | 2.36612 |
| 91.60000 | −6.00898 | 4.11626 | 135.56800 | −5.99388 | 2.90261 | 179.53600 | −6.21165 | 2.37100 |
| 91.60000 | −4.50242 | 3.88630 | 135.56800 | −4.74584 | 2.81596 | 179.53600 | −5.18998 | 2.34024 |
| 91.60000 | −2.88044 | 3.58175 | 135.56800 | −3.39724 | 2.68028 | 179.53600 | −4.08464 | 2.27267 |
| 91.60000 | −1.16195 | 3.20492 | 135.56800 | −1.96379 | 2.49583 | 179.53600 | −2.90847 | 2.16800 |
| 91.60000 | 0.63160 | 2.75943 | 135.56800 | −0.46334 | 2.26380 | 179.53600 | −1.67608 | 2.02663 |
| 91.60000 | 2.47829 | 2.24970 | 135.56800 | 1.08578 | 1.98589 | 179.53600 | −0.40249 | 1.84936 |
| 91.60000 | 4.35386 | 1.68093 | 135.56800 | 2.66330 | 1.66438 | 179.53600 | 0.89569 | 1.63741 |
| 91.60000 | 6.23539 | 1.06286 | 135.56800 | 4.24988 | 1.30615 | 179.53600 | 2.20257 | 1.39659 |
| 91.60000 | 8.09710 | 0.40284 | 135.56800 | 5.82407 | 0.91630 | 179.53600 | 3.50060 | 1.13114 |
| 91.60000 | 9.91496 | −0.29062 | 135.56800 | 7.36551 | 0.49962 | 179.53600 | 4.77300 | 0.84427 |
| 91.60000 | 11.66440 | −1.00466 | 135.56800 | 8.85305 | 0.06413 | 179.53600 | 6.00220 | 0.54168 |
| 91.60000 | 13.32420 | −1.72379 | 135.56800 | 10.26800 | −0.38013 | 179.53600 | 7.17257 | 0.23072 |
| 91.60000 | 14.87260 | −2.43067 | 135.56800 | 11.59100 | −0.82161 | 179.53600 | 8.26793 | −0.08010 |
| 91.60000 | 16.29140 | −3.10551 | 135.56800 | 12.80540 | −1.24695 | 179.53600 | 9.27424 | −0.38076 |
| 91.60000 | 17.56170 | −3.73304 | 135.56800 | 13.89470 | −1.64601 | 179.53600 | 10.17750 | −0.66390 |
| 91.60000 | 18.66540 | −4.30110 | 135.56800 | 14.84280 | −2.01093 | 179.53600 | 10.96440 | −0.92402 |
| 91.60000 | 19.58500 | −4.80514 | 135.56800 | 15.63510 | −2.33945 | 179.53600 | 11.62280 | −1.16011 |
| 91.60000 | 20.30040 | −5.23010 | 135.56800 | 16.25390 | −2.62150 | 179.53600 | 12.13800 | −1.36497 |
| 91.60000 | 20.80290 | −5.54059 | 135.56800 | 16.68920 | −2.83011 | 179.53600 | 12.50070 | −1.51722 |
| 91.60000 | 21.09810 | −5.71906 | 135.56800 | 16.94460 | −2.95034 | 179.53600 | 12.71340 | −1.60473 |
| 91.60000 | 21.19530 | −5.77537 | 135.56800 | 17.02840 | −2.98815 | 179.53600 | 12.78320 | −1.63209 |
| Lower aerofoil characteristic line d | | | Lower aerofoil characteristic line f | | | Lower aerofoil characteristic line h | | |
|---|---|---|---|---|---|---|---|---|
| x | y | z | x | y | z | x | y | z |
| 91.60000 | −12.35420 | 3.60535 | 135.56800 | −11.11360 | 2.20977 | 179.53600 | −10.36920 | 1.64138 |
| 91.60000 | −12.31890 | 3.42979 | 135.56800 | −11.06710 | 2.09407 | 179.53600 | −10.32750 | 1.54842 |
| 91.60000 | −12.07910 | 3.21678 | 135.56800 | −10.84910 | 1.96974 | 179.53600 | −10.14550 | 1.45390 |
| 91.60000 | −11.64250 | 3.01175 | 135.56800 | −10.47130 | 1.86218 | 179.53600 | −9.83367 | 1.37819 |
| 91.60000 | −11.01890 | 2.77956 | 135.56800 | −9.93907 | 1.74355 | 179.53600 | −9.39536 | 1.29839 |
| 91.60000 | −10.20790 | 2.53330 | 135.56800 | −9.25308 | 1.62361 | 179.53600 | −8.83148 | 1.22245 |
| 91.60000 | −9.21378 | 2.27295 | 135.56800 | −8.41707 | 1.50107 | 179.53600 | −8.14504 | 1.14918 |
| 91.60000 | −8.04463 | 1.99567 | 135.56800 | −7.43744 | 1.37309 | 179.53600 | −7.34117 | 1.07608 |
| 91.60000 | −6.71290 | 1.69859 | 135.56800 | −6.32417 | 1.23643 | 179.53600 | −6.42793 | 1.00016 |
| 91.60000 | −5.23267 | 1.37821 | 135.56800 | −5.08848 | 1.08746 | 179.53600 | −5.41434 | 0.91812 |
| 91.60000 | −3.62258 | 1.03280 | 135.56800 | −3.74546 | 0.92363 | 179.53600 | −4.31266 | 0.82739 |
| 91.60000 | −1.90265 | 0.66095 | 135.56800 | −2.31133 | 0.74261 | 179.53600 | −3.13605 | 0.72555 |
| 91.60000 | −0.09524 | 0.26304 | 135.56800 | −0.80438 | 0.54337 | 179.53600 | −1.89940 | 0.61115 |
| 91.60000 | 1.77647 | −0.16075 | 135.56800 | 0.75648 | 0.32468 | 179.53600 | −0.61812 | 0.48262 |
| 91.60000 | 3.68728 | −0.60848 | 135.56800 | 2.35053 | 0.08658 | 179.53600 | 0.69089 | 0.33929 |
| 91.60000 | 5.61221 | −1.07751 | 135.56800 | 3.95720 | −0.17035 | 179.53600 | 2.01079 | 0.18099 |
| 91.60000 | 7.52477 | −1.56285 | 135.56800 | 5.55440 | −0.44408 | 179.53600 | 3.32351 | 0.00868 |
| 91.60000 | 9.39975 | −2.06013 | 135.56800 | 7.12127 | −0.73251 | 179.53600 | 4.61193 | −0.17661 |
| 91.60000 | 11.21060 | −2.56348 | 135.56800 | 8.63574 | −1.03214 | 179.53600 | 5.85794 | −0.37271 |
| 91.60000 | 12.93300 | −3.06766 | 135.56800 | 10.07780 | −1.33958 | 179.53600 | 7.04506 | −0.57752 |
| 91.60000 | 14.54250 | −3.56443 | 135.56800 | 11.42690 | −1.64904 | 179.53600 | 8.15641 | −0.78694 |
| 91.60000 | 16.01710 | −4.04740 | 135.56800 | 12.66490 | −1.95570 | 179.53600 | 9.17692 | −0.99765 |
| 91.60000 | 17.33610 | −4.50810 | 135.56800 | 13.77420 | −2.25350 | 179.53600 | 10.09210 | −1.20524 |
| 91.60000 | 18.48020 | −4.93749 | 135.56800 | 14.73870 | −2.53599 | 179.53600 | 10.88850 | −1.40497 |
| 91.60000 | 19.43330 | −5.32624 | 135.56800 | 15.54440 | −2.79693 | 179.53600 | 11.55460 | −1.59219 |
| 91.60000 | 20.17440 | −5.66302 | 135.56800 | 16.17330 | −3.02808 | 179.53600 | 12.07550 | −1.76076 |
| 91.60000 | 20.69130 | −5.92376 | 135.56800 | 16.61400 | −3.20967 | 179.53600 | 12.44110 | −1.89489 |
| 91.60000 | 20.99120 | −6.08626 | 135.56800 | 16.87070 | −3.32327 | 179.53600 | 12.65430 | −1.97941 |
| 91.60000 | 21.08910 | −6.14022 | 135.56800 | 16.95450 | −3.36090 | 179.53600 | 12.72390 | −2.00745 |

4. The blade of a rotor craft according to claim 3, wherein the upper aerofoil characteristic line and the lower aerofoil characteristic line are further defined according to following tables:

| Upper aerofoil characteristic line b | | | Lower aerofoil characteristic line b | | |
|---|---|---|---|---|---|
| x | y | z | x | y | z |
| 48.31900 | −10.01800 | 1.99222 | 48.31900 | −10.01800 | 1.99222 |
| 48.31900 | −9.90122 | 2.24722 | 48.31900 | −10.00190 | 1.73932 |
| 48.31900 | −9.60006 | 2.59888 | 48.31900 | −9.83032 | 1.43726 |
| 48.31900 | −9.15774 | 2.91044 | 48.31900 | −9.50213 | 1.17308 |
| 48.31900 | −8.57465 | 3.17850 | 48.31900 | −9.02409 | 0.91120 |
| 48.31900 | −7.85424 | 3.39834 | 48.31900 | −8.39578 | 0.66641 |
| 48.31900 | −7.00283 | 3.55484 | 48.31900 | −7.61970 | 0.44287 |
| 48.31900 | −6.02629 | 3.64656 | 48.31900 | −6.70207 | 0.23742 |
| 48.31900 | −4.93423 | 3.66984 | 48.31900 | −5.65234 | 0.04716 |
| 48.31900 | −3.73656 | 3.62525 | 48.31900 | −4.48152 | −0.13293 |
| 48.31900 | −2.44713 | 3.51305 | 48.31900 | −3.20423 | −0.30633 |
| 48.31900 | −1.08061 | 3.33508 | 48.31900 | −1.83623 | −0.47685 |
| 48.31900 | 0.34625 | 3.09381 | 48.31900 | −0.39524 | −0.64683 |
| 48.31900 | 1.81632 | 2.79265 | 48.31900 | 1.10035 | −0.81921 |
| 48.31900 | 3.31055 | 2.43515 | 48.31900 | 2.63053 | −0.99534 |
| 48.31900 | 4.81076 | 2.02927 | 48.31900 | 4.17543 | −1.17586 |
| 48.31900 | 6.29639 | 1.57926 | 48.31900 | 5.71415 | −1.35802 |
| 48.31900 | 7.74841 | 1.09160 | 48.31900 | 7.22641 | −1.54175 |
| 48.31900 | 9.14728 | 0.57722 | 48.31900 | 8.69052 | −1.72703 |
| 48.31900 | 10.47610 | 0.05046 | 48.31900 | 10.08640 | −1.91546 |
| 48.31900 | 11.71730 | −0.47323 | 48.31900 | 11.39370 | −2.10604 |
| 48.31900 | 12.85640 | −0.97477 | 48.31900 | 12.59360 | −2.30058 |
| 48.31900 | 13.87820 | −1.44087 | 48.31900 | 13.66880 | −2.49704 |
| 48.31900 | 14.76780 | −1.86193 | 48.31900 | 14.60340 | −2.69148 |
| 48.31900 | 15.51110 | −2.23700 | 48.31900 | 15.38420 | −2.87680 |
| 48.31900 | 16.09170 | −2.55415 | 48.31900 | 15.99380 | −3.04763 |
| 48.31900 | 16.50100 | −2.78215 | 48.31900 | 16.42000 | −3.19068 |
| 48.31900 | 16.74220 | −2.90842 | 48.31900 | 16.66720 | −3.28677 |
| 48.31900 | 16.82160 | −2.94709 | 48.31900 | 16.74770 | −3.31983. |

5. The blade of the rotor craft according to claim 1, wherein a backswept portion (171) is formed at the blade tip (17), the backswept portion (171) bends and extends from the front edge (11) toward the tail edge (12), and an upper aerofoil characteristic line and a lower aerofoil characteristic line of the backswept portion (171) are defined according to following tables:

| Upper aerofoil characteristic line j | | | Upper aerofoil characteristic line k | | |
|---|---|---|---|---|---|
| x | y | z | x | y | z |
| 209.76400 | −8.69407 | 0.91068 | 222.58800 | 0.09175 | −0.00367 |
| 209.76400 | −8.63887 | 0.98709 | 222.58800 | 0.12954 | 0.04671 |
| 209.76400 | −8.46076 | 1.11139 | 222.58800 | 0.25533 | 0.12543 |
| 209.76400 | −8.17652 | 1.23329 | 222.58800 | 0.45873 | 0.20185 |
| 209.76400 | −7.78691 | 1.34340 | 222.58800 | 0.73962 | 0.27185 |
| 209.76400 | −7.29365 | 1.44242 | 222.58800 | 1.09669 | 0.33536 |
| 209.76400 | −6.69984 | 1.52350 | 222.58800 | 1.52795 | 0.38844 |
| 209.76400 | −6.00963 | 1.58489 | 222.58800 | 2.03043 | 0.43021 |
| 209.76400 | −5.22969 | 1.62357 | 222.58800 | 2.59938 | 0.45907 |
| 209.76400 | −4.36731 | 1.63811 | 222.58800 | 3.22956 | 0.47437 |
| 209.76400 | −3.43256 | 1.62702 | 222.58800 | 3.91364 | 0.47537 |
| 209.76400 | −2.43627 | 1.58944 | 222.58800 | 4.64378 | 0.46168 |
| 209.76400 | −1.39077 | 1.52501 | 222.58800 | 5.41097 | 0.43317 |
| 209.76400 | −0.30877 | 1.43367 | 222.58800 | 6.20592 | 0.38986 |
| 209.76400 | 0.79565 | 1.31566 | 222.58800 | 7.01835 | 0.33191 |
| 209.76400 | 1.90892 | 1.17583 | 222.58800 | 7.83826 | 0.26397 |
| 209.76400 | 3.01612 | 1.01776 | 222.58800 | 8.65473 | 0.18991 |
| 209.76400 | 4.10294 | 0.84321 | 222.58800 | 9.45722 | 0.11046 |
| 209.76400 | 5.15428 | 0.65580 | 222.58800 | 10.23450 | 0.02720 |
| 209.76400 | 6.15655 | 0.46042 | 222.58800 | 10.97640 | −0.05772 |
| 209.76400 | 7.09567 | 0.26284 | 222.58800 | 11.67240 | −0.14191 |
| 209.76400 | 7.95927 | 0.07003 | 222.58800 | 12.31310 | −0.22234 |
| 209.76400 | 8.73515 | −0.11313 | 222.58800 | 12.88920 | −0.29732 |
| 209.76400 | 9.41175 | −0.28318 | 222.58800 | 13.39230 | −0.36609 |
| 209.76400 | 9.97877 | −0.44012 | 222.58800 | 13.81450 | −0.42982 |
| 209.76400 | 10.42340 | −0.57914 | 222.58800 | 14.14640 | −0.48707 |
| 209.76400 | 10.73680 | −0.68372 | 222.58800 | 14.38060 | −0.52996 |
| 209.76400 | 10.92050 | −0.74384 | 222.58800 | 14.51790 | −0.55392 |
| 209.76400 | 10.98070 | −0.76252 | 222.58800 | 14.56290 | −0.56114 |
| Lower aerofoil characteristic line j | | | Lower aerofoil characteristic line k | | |
|---|---|---|---|---|---|
| x | y | z | x | y | z |
| 209.76400 | −8.69407 | 0.91068 | 222.58800 | 0.09175 | −0.00367 |
| 209.76400 | −8.65377 | 0.84410 | 222.58800 | 0.12338 | −0.04848 |
| 209.76400 | −8.49485 | 0.78437 | 222.58800 | 0.24125 | −0.09226 |
| 209.76400 | −8.22750 | 0.74418 | 222.58800 | 0.43767 | −0.12373 |
| 209.76400 | −7.85344 | 0.70510 | 222.58800 | 0.71214 | −0.15304 |
| 209.76400 | −7.37382 | 0.67331 | 222.58800 | 1.06358 | −0.17661 |
| 209.76400 | −6.79116 | 0.64740 | 222.58800 | 1.49023 | −0.19475 |
| 209.76400 | −6.10967 | 0.62513 | 222.58800 | 1.98910 | −0.20867 |
| 209.76400 | −5.33600 | 0.60369 | 222.58800 | 2.55547 | −0.21982 |
| 209.76400 | −4.47759 | 0.58009 | 222.58800 | 3.18400 | −0.22992 |
| 209.76400 | −3.54464 | 0.55177 | 222.58800 | 3.86734 | −0.24039 |
| 209.76400 | −2.54813 | 0.51629 | 222.58800 | 4.59757 | −0.25267 |
| 209.76400 | −1.50054 | 0.47193 | 222.58800 | 5.36562 | −0.26783 |
| 209.76400 | −0.41476 | 0.41684 | 222.58800 | 6.16214 | −0.28700 |
| 209.76400 | 0.69499 | 0.34989 | 222.58800 | 6.97677 | −0.31097 |
| 209.76400 | 1.81453 | 0.27030 | 222.58800 | 7.79918 | −0.34031 |
| 209.76400 | 2.92859 | 0.17805 | 222.58800 | 8.61819 | −0.37503 |
| 209.76400 | 4.02270 | 0.07343 | 222.58800 | 9.42321 | −0.41525 |
| 209.76400 | 5.08150 | −0.04237 | 222.58800 | 10.20290 | −0.46067 |
| 209.76400 | 6.09105 | −0.16799 | 222.58800 | 10.94710 | −0.51107 |
| 209.76400 | 7.03695 | −0.30051 | 222.58800 | 11.64500 | −0.56537 |
| 209.76400 | 7.90637 | −0.43745 | 222.58800 | 12.28720 | −0.62289 |
| 209.76400 | 8.68695 | −0.57555 | 222.58800 | 12.86430 | −0.68231 |
| 209.76400 | 9.36712 | −0.71137 | 222.58800 | 13.36790 | −0.74210 |
| 209.76400 | 9.93692 | −0.84160 | 222.58800 | 13.79050 | −0.80055 |
| 209.76400 | 10.38350 | −0.96166 | 222.58800 | 14.12250 | −0.85557 |
| 209.76400 | 10.69770 | −1.05867 | 222.58800 | 14.35660 | −0.90106 |
| 209.76400 | 10.88130 | −1.12012 | 222.58800 | 14.49360 | −0.93050 |
| 209.76400 | 10.94130 | −1.14047 | 222.58800 | 14.53830 | −0.94034. |

6. The blade of a rotor craft according to claim 5, wherein the upper aerofoil characteristic line and the lower aerofoil characteristic line of the backswept portion (171) are further defined according to following tables:

| Upper aerofoil characteristic line 1 | | | Lower aerofoil characteristic line 1 | | |
|---|---|---|---|---|---|
| x | y | z | x | y | z |
| 228.83000 | 8.82439 | −0.38479 | 228.83000 | 8.82439 | −0.38479 |
| 228.82900 | 8.85115 | −0.35168 | 228.82900 | 8.84826 | −0.41795 |
| 228.82500 | 8.94159 | −0.30742 | 228.82600 | 8.93497 | −0.45898 |
| 228.82000 | 9.08881 | −0.26856 | 228.82000 | 9.07891 | −0.49524 |
| 228.81100 | 9.29294 | −0.23455 | 228.81200 | 9.28002 | −0.53038 |
| 228.80100 | 9.55299 | −0.20627 | 228.80100 | 9.53742 | −0.56272 |
| 228.78700 | 9.86760 | −0.18539 | 228.78800 | 9.84987 | −0.59143 |
| 228.77100 | 10.23470 | −0.17199 | 228.77200 | 10.21520 | −0.61680 |
| 228.75200 | 10.65070 | −0.16635 | 228.75300 | 10.63010 | −0.63902 |
| 228.73000 | 11.11200 | −0.16827 | 228.73100 | 11.09060 | −0.65862 |
| 228.70500 | 11.61310 | −0.17761 | 228.70600 | 11.59140 | −0.67595 |
| 228.67800 | 12.14840 | −0.19407 | 228.67900 | 12.12670 | −0.69144 |
| 228.64700 | 12.71130 | −0.21729 | 228.64800 | 12.69000 | −0.70536 |
| 228.61400 | 13.29500 | −0.24682 | 228.61500 | 13.27440 | −0.71809 |
| 228.57800 | 13.89190 | −0.28222 | 228.57900 | 13.87240 | −0.72982 |
| 228.54100 | 14.49480 | −0.31860 | 228.54200 | 14.47630 | −0.74069 |
| 228.50200 | 15.09550 | −0.35161 | 228.50300 | 15.07810 | −0.75037 |
| 228.46200 | 15.68640 | −0.38094 | 228.46300 | 15.66990 | −0.75900 |
| 228.42200 | 16.25920 | −0.40623 | 228.42300 | 16.24350 | −0.76685 |
| 228.38200 | 16.80640 | −0.42707 | 228.38400 | 16.79120 | −0.77445 |
| 228.34400 | 17.32000 | −0.44337 | 228.34500 | 17.30520 | −0.78211 |
| 228.30800 | 17.79310 | −0.45480 | 228.30900 | 17.77840 | −0.79052 |
| 228.27400 | 18.21880 | −0.46189 | 228.27500 | 18.20400 | −0.79984 |
| 228.24400 | 18.59070 | −0.46571 | 228.24500 | 18.57570 | −0.80993 |
| 228.21800 | 18.90330 | −0.46825 | 228.22000 | 18.88790 | −0.82010 |
| 228.19800 | 19.14920 | −0.47040 | 228.19900 | 19.13350 | −0.83012 |
| 228.18300 | 19.32300 | −0.47097 | 228.18500 | 19.30690 | −0.83942 |
| 228.17500 | 19.42480 | −0.46991 | 228.17600 | 19.40840 | −0.84634 |
| 228.17200 | 19.45820 | −0.46920 | 228.17300 | 19.44160 | −0.84884. |

7. The blade of a rotor craft according to claim 1, wherein the blade comprises at least two blades (1), and the at least two blades (1) are connected to each other by using the blade root (16), and are symmetrical about a central point of a joint.

8. The blade of a rotor craft according to claim 7, wherein the at least two blades (1) are integrally formed or separately formed.

9. A rotor of a rotor craft, the rotor comprising the blade of a rotor craft according to claim 1 and a hub, wherein the blade is mounted to a driving assembly of the rotor craft by using the hub.

10. A rotor craft, comprising the blade of a rotor craft according to claim 1.

11. The rotor craft according to claim 10, wherein the rotor craft is a multi-rotor craft.
